(19) United States
(12) Patent Application Publication
(10) Pub. No.: US 2025/0342212 A1
(43) Pub. Date: Nov. 6, 2025

(54) Metadata Management System for Smart Digital Manufacturing

(71) Applicant: KORE Power, Inc., Coeur d’Alene, ID (US)

(72) Inventor: Dan Grebenisan, Peoria, AZ (US)

(21) Appl. No.: 18/656,460

(22) Filed: May 6, 2024

(51) Int. Cl. G06F 16/907

(52) U.S. Cl. CPC G06F 16/907

(57) ABSTRACT

In one embodiment, a method includes, by one or more computing systems for metadata management in manufacturing systems: receiving, at a container manager module, from multiple metadata sources associated with a respective multiple manufacturing equipment systems, multiple metadata messages; generating, by the container manager module, multiple metadata records associated with the respective multiple metadata messages, each metadata record being decoupled from the metadata sources; publishing, by the container manager module, asynchronously into a message queue module, multiple metadata records; recording, by one or more software modules associated with a metadata tracking database, for each published metadata record, an event record including one or more event datapoints associated with the metadata record, each event datapoint being based on a processing event associated with the metadata record; and determining a processing status of the metadata record based on the event record associated with the metadata record.

### TECHNICAL FIELD

This disclosure generally relates to databases and file management within network environments, and in particular relates to a metadata management system for smart digital manufacturing.

### BACKGROUND

In digital manufacturing, automation devices and components are traditionally located in level one or two (i.e., automation layers) of a Purdue model, which, for example, may be Programmable Logic Controllers (PLC) communicating with upper middleware systems such as Manufacturing Execution Systems (MES), Manufacturing Management Systems (MMS), Manufacturing Operations Management (MoM) systems, Supervisory Control and Data Acquisition (SCADA) systems, using industrial protocols like Open Platform Communications (OPC), Open Platform Communications Unified Architecture (OPC-UA), MODBUS, Process Field Network (PROFINET), or other industrial protocols for collecting and sending data from the automation layers. These communication protocols may implement and support concepts in the industry as “tags” or “datapoints” inside the automation devices, which may correspond to memory addresses within each PLC or other automation device. The data values of these tags or datapoints may be uploaded to the manufacturing management systems located in level three or four (i.e., operation layers) in the Purdue model, typically each time when the values of the tags change, for example, on a timer basis or by request. However, these architectures have limitations in terms of the amount and the type of data they can send, for example, from the automation layers to the operation layers.

In today's manufacturing space, there are more and more industrial computers operating at the automation layers, performing complex functions, running artificial intelligence or machine learning models, and performing advanced data collection and processing. Because of the data type and transmission speed limitation of the traditional systems, PLCs and existing industrial protocols may not be capable of processing new types of data, computing complex models and algorithms, or transferring new types of data in a fast or deterministic way.

For one or more of these reasons, increasing amounts of manufacturing equipment perform advanced processing of special data locally, which is often referred to in the industry as “at the edge.” Data streams from local computing systems are locally processed at the edge, sometimes through machine learning models by full-fledged computers. The result of such local processing and machine learning inference is aggregated, together with other relevant attributes of the current process, into metadata packets that describe the summary of the current process in snapshots of data collection.

Currently, there lacks an efficient way to manage and process this new type of data i.e., the metadata packets from industrial computers that are generated as a result of artificial intelligence inference. Also, there lacks a way of transferring this new type of data in real-time or in a deterministic way. For example, the protocols currently used are often general-purpose or internet-based protocols, which are not designed to transfer the data in real-time with certainty. Moreover, existing systems or technologies are designed with simple point-to-point communication (e.g., from industrial computers to manufacturing management systems) and do not provide solutions such as modular design, asynchronous decoupling, load balancing, efficient dispatch to multiple consumer systems, reliability and data loss recovery, scalability, efficient data and platform management, deterministic data transfer while decoupling data sources from data consumers, among others.

### SUMMARY OF PARTICULAR EMBODIMENTS

There is a need for a new solution for transmitting, processing, and dispatching metadata, which, for example, may result from the inference of artificial intelligence (AI) or machine learning (ML) models running at the edge of manufacturing equipment systems.

Embodiments according to this disclosure may generally relate to information systems, control and automation, AI and ML, computer networks, electronic data transmission, computerized data architecture, or data processing, which may be applied in the field of digital manufacturing or advanced manufacturing. Although the embodiments in this disclosure are described with application to particular types of manufacturing in a particular manner, this disclosure contemplates application to any suitable type of manufacturing in any suitable manner. Particular embodiments may efficiently receive metadata from AI/ML models running at the edge in such a way that metadata senders may be asynchronously decoupled from the receivers. Particular embodiments may dynamically manage multiple message senders with the ability to efficiently add new metadata senders, add or change the number of metadata topics received from the senders, add or change the structures of the topics, increase the overall efficiency of data management, or perform other desired functions of metadata management. Particular embodiments may provide novel ways to ensure data integrity as well as deterministic delivery of the metadata to the registered end-consumer systems. Particular embodiments may have a modular and scalable design, ensuring the load balancing of the metadata flowing from multiple data sources and allowing efficient management of associated platforms.

In particular embodiments, a method includes, by one or more computing systems for metadata management in manufacturing systems: receiving, at a container manager module, from multiple metadata sources associated with a respective multiple manufacturing equipment systems, multiple metadata messages; generating, by the container manager module, multiple metadata records associated with the respective multiple metadata messages, each metadata record being decoupled from the metadata sources; publishing, by the container manager module, asynchronously into a message queue module, multiple metadata records; recording, by one or more software modules associated with a metadata tracking database, for each published metadata record, an event record including one or more event datapoints associated with the metadata record, each event datapoint being based on a processing event associated with the metadata record; and determining a processing status of the metadata record based on the event record associated with the metadata record.

In particular embodiments, the method further includes: generating, by the message queue module, a subscription event corresponding to each published metadata record. Each subscription event is configured to notify one or more subscriber modules each associated with one or more end-consumer systems. Each metadata record is further decoupled from the end-consumer systems.

In particular embodiments, one or more of the subscriber modules are configured to convert metadata records into a format corresponding to an industrial protocol associated with one or more of the end-consumer systems associated with the subscriber module.

In particular embodiments, each processing event is associated with one or more of the container manager module, the message queue module, one or more end-consumer systems, or one or more subscriber modules associated with one or more of the end-consumer systems.

In particular embodiments, each metadata record includes a unique identifier assigned to the associated metadata message.

In particular embodiments, recording the event record and determining the processing status of the metadata record is based on the unique identifier assigned to the associated metadata message.

In particular embodiments, the container manager module includes multiple container modules. Each container module corresponds to a manufacturing equipment system of multiple manufacturing equipment systems.

In particular embodiments, each container module includes a microservice configured to receive metadata messages from the metadata source associated with the manufacturing equipment system corresponding to the container.

In particular embodiments, each microservice is configured to assign the unique identifier to the received metadata message to generate the associated metadata record.

In particular embodiments, the microservice includes multiple endpoints to receive the metadata messages from the metadata source. Each endpoint is dedicated to receiving a particular type of metadata message.

In particular embodiments, each container module further includes a queue publisher module configured to publish metadata records to the message queue module.

In particular embodiments, the method further includes: monitoring, via a timeout watchdog module, the processing status of the metadata record by analyzing one or more event datapoints associated with the metadata record.

In particular embodiments, the method further includes: comparing, for a first metadata record of multiple metadata records, a first event datapoint associated with the first metadata record with a specified threshold associated with the processing event corresponding to the first event datapoint, and reinitiating the processing event based on a determination that the specified threshold associated with the processing event is exceeded.

In particular embodiments, each event datapoint includes a time record indicating when the corresponding processing event is completed. The specified threshold is a threshold period of time associated with the processing event.

In particular embodiments, reinitiating the processing event includes re-publishing the first metadata record to the message queue module.

In particular embodiments, the method further includes: determining, for a first metadata record of multiple metadata records, that a first event datapoint is missing from the event record for the first metadata record; and reinitiating a processing event corresponding to the first event datapoint based on the determination that the first event datapoint is missing from the event record.

In particular embodiments, the method further includes: determining, for a first metadata record of multiple metadata records, that the processing status of the first metadata record satisfies a predetermined condition; and terminating subsequent determinations of the processing status of the first metadata record.

In particular embodiments, each event datapoint includes a time record indicating when the corresponding processing event is completed. The predetermined condition is a threshold period of time associated with completion of one or more processing events for the first metadata record.

In particular embodiments, the method further includes: removing the event record for the first metadata record from the metadata tracking database when the processing status of the first metadata record satisfies the predetermined condition.

In particular embodiments, the method further includes: generating a distribution for each metadata record based on the event record of the metadata record; and determining a threshold for a particular processing event based on the distribution, the threshold being associated with a type of the metadata record.

In particular embodiments, each processing event corresponds to one of multiple processing event types including: delivering the metadata record to one or more subscriber modules each associated with one or more end-consumer systems; receiving the metadata record by the one or more subscriber modules; delivering the metadata record to the one or more end-consumer systems; or receiving the metadata record by the one or more end-consumer systems.

In particular embodiments, a system for digital manufacturing includes: one or more processors; and one or more computer-readable non-transitory storage media coupled to one or more of the processors and including instructions operable when executed by one or more of the processors to cause the system to: receive, at a container manager module, from multiple metadata sources associated with a respective multiple manufacturing equipment systems, multiple metadata messages; generate, by the container manager module, multiple metadata records associated with the respective multiple metadata messages, each metadata record being decoupled from the metadata sources; publish, by the container manager module, asynchronously into a message queue module, multiple metadata records; record, by one or more software modules associated with a metadata tracking database, for each published metadata record, an event record including one or more event datapoints associated with the metadata record, each event datapoint being based on a processing event associated with the metadata record; and determine a processing status of the metadata record based on the event record associated with the metadata record.

In particular embodiments, one or more computer-readable non-transitory storage media includes software that is operable when executed to: receive, at a container manager module, from multiple metadata sources associated with a respective multiple manufacturing equipment systems, multiple metadata messages; generate, by the container manager module, multiple metadata records associated with the respective multiple metadata messages, each metadata record being decoupled from the metadata sources; publish, by the container manager module, asynchronously into a message queue module, multiple metadata records; record, by one or more software modules associated with a metadata tracking database, for each published metadata record, an event record including one or more event datapoints associated with the metadata record, each event datapoint being based on a processing event associated with the metadata record; and determine a processing status of the metadata record based on the event record associated with the metadata record.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a system architecture of an example metadata management system.

FIG. 2 illustrates a flowchart describing the lifecycles of example metadata messages and metadata records.

FIG. 3 illustrates a system flowchart of an example metadata management system.

FIG. 4 illustrates a sequence of logical decisions by an example timeout watchdog module.

FIG. 5 illustrates a diagram showing a distribution of metadata record delivery density and a logistic regression associated with an example real-time optimizer module.

FIG. 6 illustrates an example method for metadata management for smart digital manufacturing.

FIG. 7 illustrates an example computer system.

### DESCRIPTION OF EXAMPLE EMBODIMENTS

Embodiments of this disclosure may involve an electronic and computerized system for digital manufacturing environments, which may manage deterministic transfer of data structures, messages, or other forms of data and information over non-deterministic protocols while allowing them to be decoupled or loosely coupled from the source systems to the consumer systems. Particular embodiments may allow inference messages generated by AI/ML models running at the edge to be augmented with the manufacturing context of the process into metadata messages, which are decoupled from the source to the destination by an asynchronous message queue module and are tracked at each stage of delivery. Particular embodiments may provide a retry or resend mechanism as well as a way to self-analyze and self-optimize the deterministic delivery of the metadata using parameters specific to individual types of metadata messages.

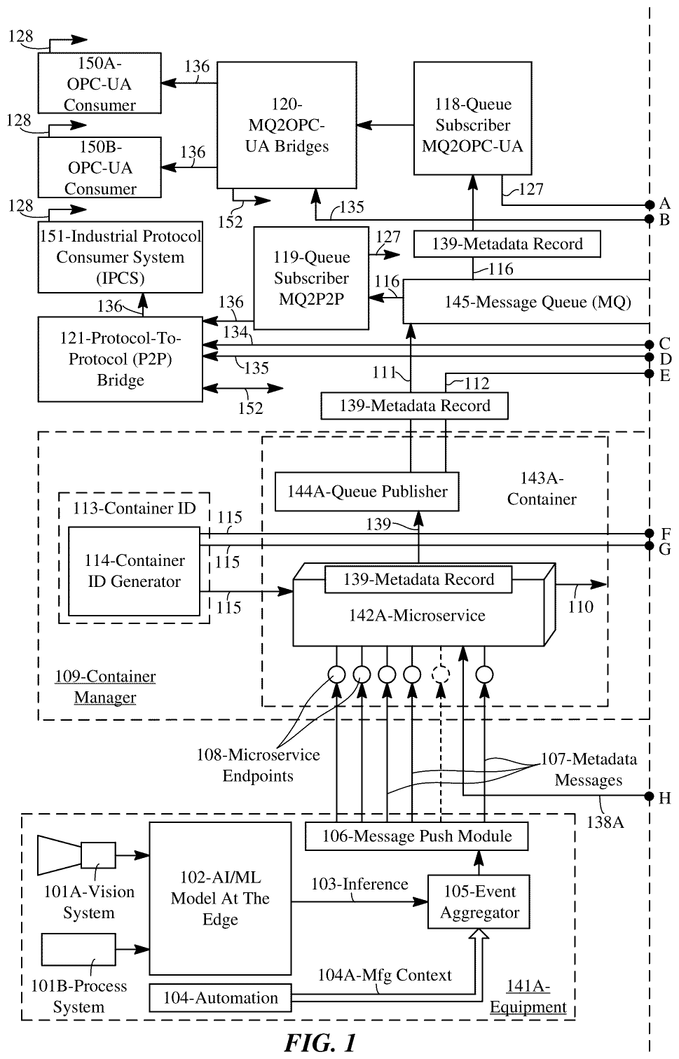

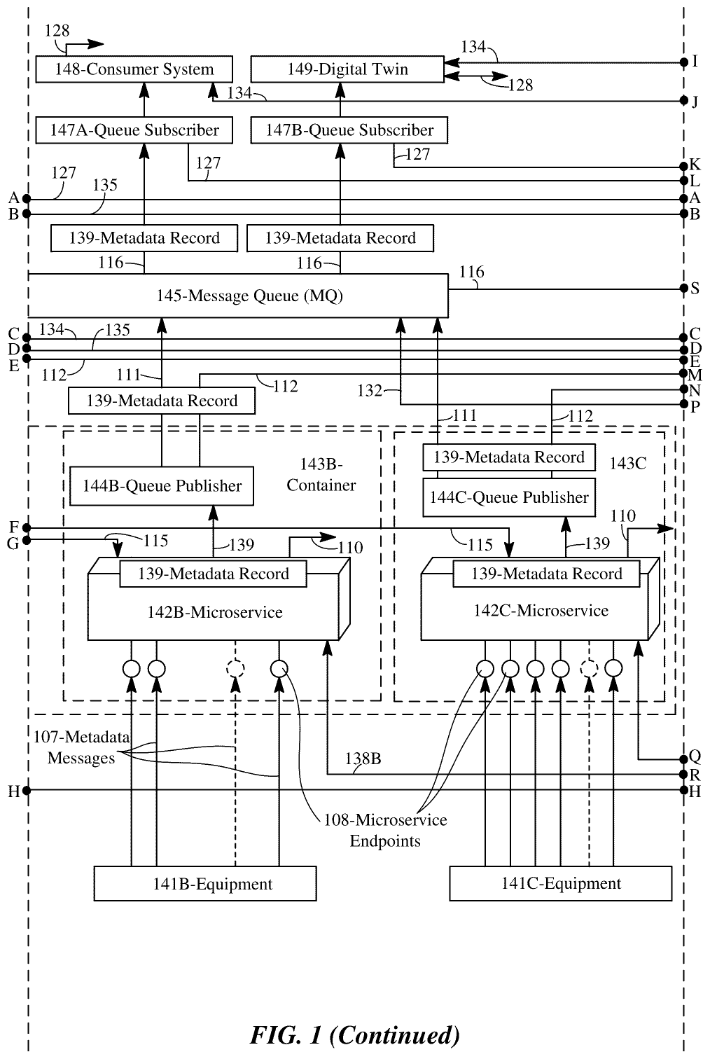

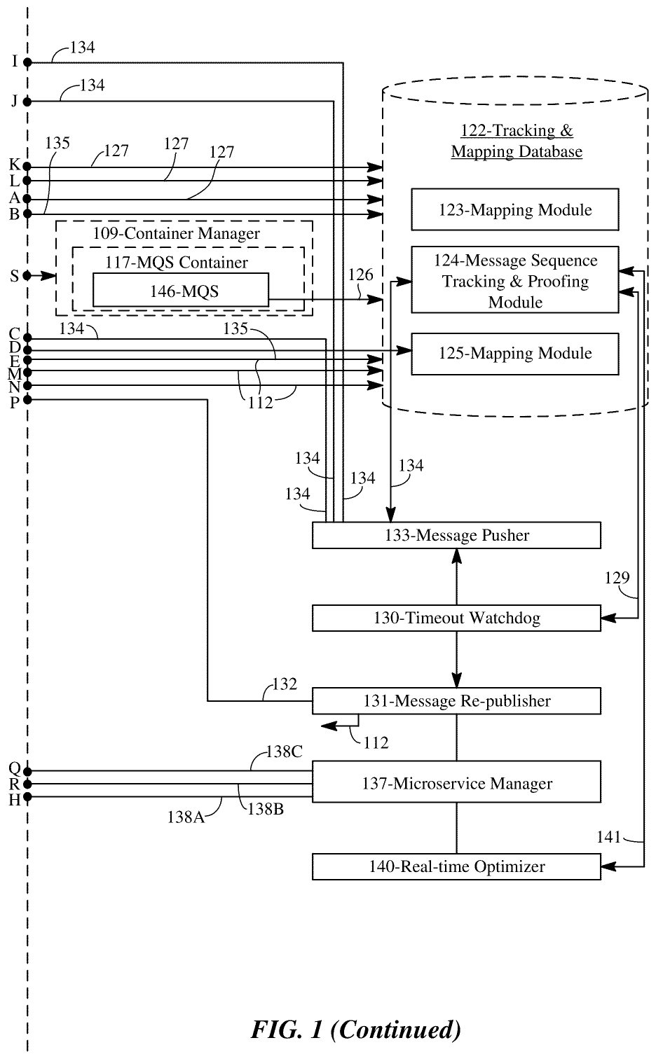

FIG. 1 illustrates a system architecture of an embodiment of a system for metadata management in digital manufacturing. In particular embodiments, manufacturing equipment 141 (i.e., 141A, 141B, 141C . . . )—or manufacturing equipment systems as used interchangeably herein—in digital manufacturing may have data collection systems such as vision systems 101A or process systems 101B, which may be configured as high-speed, high-data, or high-volume collection systems to acquire or generate relevant manufacturing data (e.g., raw manufacturing data) associated with the manufacturing process. As an example and not by way of limitation, the systems 101A, 101B, or other suitable data-gathering systems of the manufacturing equipment may run in industrial computers, which, for example, may be located at the edge or physically and logically very close to the manufacturing equipment such as inside the manufacturing equipment. Although this disclosure describes manufacturing equipment with a particular vision system and process system in a particular manner, this disclosure contemplates manufacturing equipment with any suitable vision systems and process systems in any suitable manner. In this regard, for example, the manufacturing equipment may have none, one, or multiple vision systems or process systems, which, for example, may model and collect manufacturing data from high-speed, high-data, or high-volume manufacturing processes.

In particular embodiments, the systems 101A, 101B, or other suitable data gathering systems of the manufacturing equipment 141 may generate manufacturing data, which may be processed by artificial intelligence (AI) or machine learning (ML) model 102. In particular embodiments, the AI/ML model 102 may be configured to generate inference outputs 103, which, for example, may be specific to each corresponding manufacturing process. As an example and not by way of limitation, the inference outputs 103 of the AI/ML model 102 may summarize and reduce the velocity of raw data inputs as coming from the vision system 101A and/or the process system 101B. As another example and not by way of limitation, the result of the inference outputs 103 may be a type of metadata summarizing the raw manufacturing data.

In particular embodiments, the manufacturing equipment 141 may be equipped with controls and automation module 104, which, for example, may be driven by Programmable Logic Controller (PLC) or other suitable driver devices. In particular embodiments, the automation module 104 may be configured to generate a process event context or manufacturing (Mfg) context 104A. As an example and not by way of limitation, the manufacturing context 104A may correspond to a particular manufacturing process event in which the vision system 101A and process system 101B functions. In particular embodiments, the manufacturing context 104A may contextualize the inference outputs 103 coming from the AI/ML model 102. As an example and not by way of limitation, the manufacturing context 104A, which may be specific to the inference outputs 103, may be a timestamp, originating equipment identifier (ID), operator ID, product ID (such as batch ID, manufacturing unit ID, and work order ID, etc.), and other suitable manufacturing information that may contextualize the inference outputs 103. Additionally or alternatively, the inference outputs 103 may be contextualized with other general manufacturing contexts associated with the systems 101A and 101B.

In particular embodiments, data coming from these two dual channels, namely the inference outputs 103 and the manufacturing context 104A, may be summarized and aggregated, by an event aggregator module 105, into packets, which may be referred to herein as metadata messages 107. In particular embodiments, the event aggregator module 105 may pack the data packets into a suitable format, for example, for a particular machine and/or a particular transmission over a network. As an example and not by way of limitation, one data packet may include multiple data tokens, which may be placed on the same hierarchical level. Alternatively, as another example and not by way of limitation, the packet may be nested into one or more levels, layers, hierarchies, or other suitable data structures.

The aggregated data packets may be referred to herein as metadata messages 107 because in particular embodiments they may not be raw data coming directly from the manufacturing processes, but already processed by the AI/ML models 102 generating the inference outputs 103, which may correspond to the metadata of the actual manufacturing data. In particular embodiments, the manufacturing context 104A may also be a part of the metadata of the actual raw data coming from the manufacturing event. As an example and not by way of limitation, the two types of metadata (i.e., the inference outputs 103 and the manufacturing context 104A) may contextualize and complement each other, and the merging of the two into the metadata messages 107 may make each message self-sufficient, for example, in describing a snapshot state of a complex manufacturing process.

As an example and not by way of limitation, suitable metadata message formatting for this type of data transmission over an electronic data network may be Extensible Markup Language (XML) structures sent over with Simple Object Access Protocol (SOAP), JavaScript Object Notation (JSON) structures sent over Hypertext Transfer Protocol (HTTP) and processed with Representational State Transfer (REST) standards of application programming interface (API), Remote Procedure Call (RPC) formats, or other suitable types of data transmission protocol and data format. Although this disclosure describes a metadata management system using a particular data transmission protocol with a particular data format in a particular manner, this disclosure contemplates metadata management systems using any suitable data transmission protocols with any suitable data formats in any suitable manner.

In particular embodiments, one or more manufacturing equipment 141 may send one or more types of metadata messages 107. As an example and not by way of limitation, this may depend on the number of high-velocity or high-data processes that the manufacturing equipment 141 manages, the number of AI/ML models 102 that are configured to infer these processes, the specifics of the manufacturing context 104A, and other suitable factors related to digital manufacturing.

In particular embodiments, a type of metadata message 107 may maintain the same structure, that is, the same tokens, but the value of some tokens may change with each message instance of each type. In some embodiments, different types of metadata message 107 aggregated and sent by the same manufacturing equipment 141 may have a different structure, that is different tokens. In some embodiments, tokens may be present in more than one type of metadata message 107, but the structure of the tokens in each metadata message 107 may be unique, making each type of metadata message 107 unique and different from other metadata message types coming from the same manufacturing equipment 141.

In particular embodiments, the metadata management system may include one or more container modules 143 (i.e., 143A, 143B, 143C . . . ), which may be hosted by a container manager module 109. As an example and not by way of limitation, the container manager module 109 may run on a computing hosting platform that, for example, may be independent of the computing hosting of the manufacturing equipment 141. In certain embodiments, there may be only one container manager module hosting platform in each manufacturing facility. In other embodiments, there may be multiple container manager module hosting platforms.

In particular embodiments, each of the container modules 143 hosted by the container manager module 109 may serve and be allocated to one piece of manufacturing equipment 141. As an example and not by way of limitation, the container module 143 may be a secure and fully independent computing environment. As another example and not by way of limitation, the container module 143 may be a simplified operating system that may run one or more pieces of software, which may be referred to herein as microservice. Accordingly, in particular embodiments, each of the container modules 143, which are allocated to serve respective manufacturing equipment 141, may host one of the microservices 142 (i.e., 142A, 142B, 142C . . . ).

In particular embodiments, the microservices 142 may be configured as centralized receivers of the metadata messages 107 before further processing. As an example and not by way of limitation, each piece of manufacturing equipment 141 may send one or more of the metadata messages 107 to a corresponding and allocated microservice 142. As another example and not by way of limitation, each microservice 142 may be designed with multiple microservice endpoints 108, which may be configured as communication endpoints for each type of metadata message 107 coming from the respective manufacturing equipment 141. In particular embodiments, each of these metadata message types may have a different message structure, and therefore the handling microservice 142 may have corresponding microservice endpoints 108 that are each designed for each type of metadata message 107. This way, each microservice endpoint 108 may handle elegantly and efficiently the type of metadata message 107 that is designed and allocated for the respective microservice 142 with maximum efficiency and speed. As an example and not by way of limitation, each microservice 142 may be designed with one, two, or more endpoints 108, each matching the structure of a corresponding metadata message type.

In particular embodiments, the container manager module 109 may be configured to manage the lifecycle of the container modules 143. As an example and not by way of limitation, upon startup, the container manager module 109 may load up and initialize the container modules 143. The container manager module 109 may continuously monitor the health status of each container module 143, and in case any container module 143 fails or collapses, the container manager module 109 may start a new healthy instance of the previously faulty container. Also, in particular embodiments, in instances with very high data traffic and a microservice is not capable of processing all volume of the incoming traffic, the container manager module 109 may launch a new instance of container hosting a twin of the overloaded microservice. As an example and not by way of limitation, the twin container may host a twin microservice that can take over at least some of the load. In certain embodiments, the container manager module 109 may be responsible for managing the load balancing of each microservice 142 allocated to and running in each container module 143.

In particular embodiments, each microservice 142 may be exposed to a corresponding piece of manufacturing equipment 141 as a specific Unified Resource Locator (URL), which may be unique and dedicated to serving one (e.g., only one) piece of manufacturing equipment 141 and the metadata message types associated with the piece of manufacturing equipment 141. In particular embodiments, the manufacturing equipment 141 may include a message push module 106, which may be configured to connect with the corresponding microservice 142 using a matching URL. As an example and not by way of limitation, this URL configuration may be part of a setup of the message push module 106, which may be done at the time of installation of the manufacturing equipment 141 or adjusted later.

In particular embodiments, the URL may have a general component of the container manager module 109 and one or more subcomponents defining each container module 143 and the hosted microservice 142. As an example and not by way of limitation, the microservice subcomponent of the URL may be unique across all microservices 142 and may be saved in a container ID generator 114. At the startup of the container module 143 and the loading of the microservice 142, the exposed URL may be the one saved in the container ID generator 114. This may ensure that the URL presented by the microservice 142 matches the corresponding URL used by the message push module 106 to send the metadata messages 107.

In particular embodiments, the microservices 142 may be managed by a microservice manager module 137, which, for example, may be configured to manage deployment or redeployment of the microservices 142. In a typical production environment, there may be systems or software upgrades put in place to accommodate the improved functionality of manufacturing equipment. As an example and not by way of limitation, these upgrades may be reflected in the signature of one or more metadata messages 107 or new metadata messages 107 coming from the manufacturing equipment 141. In some instances, changing the signature of any particular microservice endpoint 108 of a microservice 142 may require redeployment 138 (i.e., 138A, 138B, 138C . . . ) of the impacted microservice 142. In other instances, adding a new microservice endpoint 108 to any microservice 142 may require redeployment 138 of the impacted microservice 142. In particular embodiments, the microservice manager module 137 and its actions such as redeployment 138 may be configured to facilitate the change required for the microservice 142, which, for example, may be a result of changes in the signature of some of the metadata message types, driving a change in the corresponding handling microservice endpoint 108, or a result of adding one or more microservice endpoints 108 to handle new metadata message types.

In particular embodiments, upon receiving a metadata message 107 at the dedicated microservice endpoints 108, the microservice 142 may create a unique identifier (ID) 15 or may be assigned with the unique ID 115 (e.g., via the container ID generator 114), which may be attached and assigned to the metadata message 107. As an example and not by way of limitation, the unique ID 115 may be unique across different microservices 142, different microservice endpoints 108, and different time instants. Accordingly, in particular embodiments, each metadata message 107 may receive a unique ID 115 that differentiates it from other metadata messages.

In particular embodiments, the unique ID 115 may be assembled or processed by the microservice 142. As an example and not by way of limitation, the microservice 142 may take the unique ID 115 assigned by the container ID generator 114 at the time of startup—which, for example, may be a time unique for each microservice 142—and add the date and time in numeric formats as a timestamp to the string or number that makes the unique ID 115, and then append an incrementing integer to create a final ID. As an example and not by way of limitation, the granularity of the timestamp may be down to a small unit of time like seconds, milliseconds, or other suitable time units.

In particular embodiments, the microservice endpoint 108 may maintain a rotating integer, which may increment each time when the endpoint 108 receives a new metadata message 107 of the designated type. As an example and not by way of limitation, this design may be based on a realistic assumption that the number of times an instance of metadata message 107 is pushed to the microservice endpoint 108 (e.g., within the smallest unit of time such as a second or millisecond, which is captured in the unique ID 115) is less than the maximum value of the rotating integer. In particular embodiments, when the smallest unit of time increments to a nest value, the rotating integer may be reset to zero. This may ensure that, within the next smallest unit of time captured in the unique ID 115, there are fewer metadata messages 107 than the maximum number of the rotating integer. As an example and not by way of limitation, this may also be a realistic assumption—each endpoint 108 may process a single metadata message type, and the number of metadata message instances of that type may be limited by the speed of the process and the speed of network transmission, both of which may be below the maximum possible value of an integer number.

In particular embodiments, once the unique ID 115 is generated, it may be attached to the structure of the metadata message 107, turning the metadata message 107 into a metadata record 139. As an example and not by way of limitation, the unique ID assigned to each metadata message 107—now metadata record 139—may enable the metadata record 139 to be traced at different steps of message delivery. As another example and not by way of limitation, the unique ID 115 may support not only tracing the delivery status of the metadata record 139 but also delivery proofing and retrying of the metadata record 139.

In particular embodiments, when the metadata record 139 is fully generated and ready, the microservice 142 may perform one or more tasks including but not limited to: (1) recording, via a logging event 110, the newly created metadata record 139 into a message sequence tracking and proofing module 124 of a tracking and mapping database 122; and (2) passing the newly created metadata record 139 to an assigned and designated queue publisher module 144 (i.e., 144A, 144B, 144C . . . ). As an example and not by way of limitation, the logging event 110 may be a first step in adding the newly created metadata record 139 to the message sequence tracking and proofing module 124. For example, the logging event 110 may insert a new database record for the corresponding metadata record 139, which has the unique ID 115 to be identified later. Events that may occur after the initial logging event 110 may include updating events, subsequent logging events, notifying events, subscription events, delivering events, or other suitable data processing events. As an example and not by way of limitation, the logging events or other processing events may involve searching for a metadata record 139 based on its unique ID 115 and then adding event records such as new timestamps corresponding to the processing events.

In particular embodiments, the microservice 142 hosted by the corresponding container module 143 may be paired with another software module of the container module 143, i.e., a respective queue publisher module 144. As an example and not by way of limitation, the queue publisher modules 144 may be configured to receive metadata records 139 created by the corresponding microservices 142 and pass or publish the metadata records 139 to an asynchronous message queue (MQ) module 145.

In particular embodiments, publishing metadata records 139 into the message queue module 145 may be desirable, as it may help decouple manufacturing events associated with the manufacturing equipment 141 from end-consumer systems that consume the metadata records 139. Explaining further, for example, the flux of data, which may be represented by the metadata messages, may be generated and flow in a random sequence. Sometimes, the distribution of data and messages may be fairly randomly spread across a time domain. Other times, however, there may occur peaks of data inflow. In this case, if a data management system is tightly coupled, then such peaks may not only cause congestion or deadlock in data processing but also backpropagate to the data sources. As such, it may be beneficial to decouple or loose-couple the source systems and the end systems to increase efficiency in processing and avoid congestion of data from backpropagating to the data sources. In particular embodiments, the decoupling or loose coupling may be achieved via the message queue modules 145, which may be configured to decouple or loose-couple data of source systems from the consumer systems, or vice versa.

In particular embodiments, within the container module 143, the metadata records 139 received by the corresponding microservice 142 may be passed to the corresponding queue publisher module 144. In particular embodiments, one or more of the queue publisher modules 144 may perform one or more steps including but not limited to:
1) receiving the metadata record 139 from the pairing microservice 142 that the respective queue publisher module 144 is coupled with;
2) publishing the metadata record 139 to the message queue module 145 via a publishing event 111; and
3) logging the metadata record 139 into a tracking and mapping database 122 via a logging event 112.

In particular embodiments, the publishing event 111 may place the metadata record 139 into the message queue module 145. As an example and not by way of limitation, the publishing event 111 may be helpful in that it may serialize the flow of data from the manufacturing equipment 141. In other words, the queue publisher modules 144 may act as agents of the message queue module 145, with the queue publisher module 144 being dedicated to publishing the metadata records 139 received from the paired microservice 142, which in turn is dedicated to receiving and processing the metadata messages 107 sent by the corresponding piece of manufacturing equipment 141.

In particular embodiments, the queue publisher modules 144 may log the published metadata record 139 into the tracking and mapping database 122 via the logging event 112. This may help the overall system design to maintain data integrity and ensure certainty of delivering the metadata records 139 to the ultimate end-consumer systems such as OPC-UA consumer systems 150 (i.e., 150A, 150B, . . . ), industrial protocol consumer systems 151, consumer systems 148, and digital twins 149, making the data delivery deterministic. In particular embodiments, the logging event 112 of the metadata records 139 may be followed by subsequent processing events to further ensure the certainty of delivering the metadata records 139 to the end-consumer systems.

In particular embodiments, the metadata records 139 may be logged and recorded in the tracking and mapping database 122 as database records in the message sequence tracking and proofing module 124. As an example and not by way of limitation, these database records may be updated by subsequent processing events or retrieved and analyzed via event 129 by a timeout watchdog module 130. In particular embodiments, the subsequent processing events of the metadata records 139 may be supported by the message sequence tracking and proofing module 124. For example, as discussed previously, prior to the logging event 112, the metadata record 139 may be assigned the unique ID 115 from the corresponding microservice 142, which may be used to track the sequence of delivering the respective metadata record 139 as well as to prove that the metadata record 139 is delivered with certainty within a specified amount of time. In this regard, as an example and not by way of limitation, the message sequence tracking and proofing module 124 may be configured as a record-keeping ledger, which, for example, may keep track of each metadata record 139 from the logging event 110 when it is captured and logged, through different stages of delivery, and until the final delivery to the end-consumer systems or other suitable destinations.

Modern database systems may be provided with automated mechanisms to assign a unique ID to any newly inserted record. However, in particular embodiments, identification mechanism of the metadata record 139 such as the unique ID 115 may be established prior to the logging event for several reasons as discussed in the following.

In particular embodiments, the microservice 142 may add its own identifier to the metadata record 139. This way, when the end-consumer systems receive and consume the metadata record 139—and implicitly its payload, which is the metadata message 107—the end-consumer systems may know the corresponding microservice source of the metadata record 139, which may in turn point to the corresponding manufacturing equipment 141 that generates the associated metadata message 107.

In particular embodiments, the container manager module 109 may include a special container ID 13, which may be configured to host the container ID generator 114. As an example and not by way of limitation, when a new container module 143 is created by the container manager module 109 and when a corresponding microservice 142 and queue publisher module 144 are launched inside of the new container module 143, the container ID generator 114 may provide the microservice 142 with a new unique ID 115, which may represent the corresponding manufacturing equipment 141 that originates the metadata message 107. As discussed, this unique ID 115 may be useful to track and trace any metadata message 107 or its associated metadata record 139 along a processing event chain and to prove the origin of the metadata message 107. As an example and not by way of limitation, the originator manufacturing equipment 141 may add a data token or signature to the structure of the metadata message 107 together with an original timestamp indicating when the metadata message 107 was created and sent. However, there may be the risk of a piece of manufacturing equipment being connected to the wrong container and processing microservice. As a solution, in particular embodiments, the unique ID 115—which may be tightly related to the corresponding container module 143 as well as its hosted microservice 142 and queue publisher module 144—may be the actual configuration loaded by the microservice 142 and the queue publisher module 144 at startup. In other words, the unique ID 115 may be configured to load the corresponding microservice 142 that is designed to process the specific types of metadata message 107 that comes from the allocated manufacturing equipment 141 and has the specific signatures of the endpoints 108 related to that manufacturing equipment 141.

In particular embodiments, the container ID generator 114 may run in a single thread. Explaining further, as an example and not by way of limitation, when any new microservice 142 is started during initialization, it may connect to the container ID generator 114, which in turn may provide the unique ID 115 to the microservice 142. Since inside each container module 143, there may be one microservice 142 working together with one queue publisher module 144 (both of which serving one specific manufacturing equipment 141), the unique ID 115 may qualify the originator of each metadata record 139 as the corresponding manufacturing equipment 141. In particular embodiments, the unique ID 115 may be the first token in a full ID that makes one metadata record 139 unique from any other metadata records.

In particular embodiments, once the unique ID 115 corresponding to the source manufacturing equipment 141 has been added to the metadata record 139, the microservice 142 may generate a unique code that makes all metadata messages 107 coming from the same source, i.e., the same manufacturing equipment 141, unique among them. In particular embodiments, the microservice 142 may take the unique ID 115 assigned by the container ID generator 114 at startup and add a current timestamp, which may be kept by the container manager module 109 and shared with all container modules 143. In particular embodiments, the microservice 142 may also add another token with an incrementing integer. As an example and not by way of limitation, the microservice 142 may maintain an integer counter and, upon receiving and processing a new instance of metadata message 107, assign a current value of the integer to the metadata message 107, and then increment the integer for the next metadata message 107. As already discussed, this algorithm may be based on a realistic assumption that during the smallest time increment in a timestamp value—for example, a second or a millisecond—there are always fewer metadata messages to be received and processed than the maximum possible value of the incrementing integer. In particular embodiments, the counter may be reset to zero when the smallest unit of time—that is, every second or millisecond—increments, and may be incremented again for each message instance during the next time interval of the smallest time unit, thereby creating this unique ID 115.

The unique ID assigned to the metadata record 139 may be implemented in different ways. For example, in some embodiments, the assigned ID may be a structure having one or more fields, each representing a token such as an equipment ID, a timestamp field, or an incrementing integer field. In some embodiments, one or more fields or tokens may be assigned a fixed length and concatenated into an alphanumeric string or numeric representation. In some embodiments, one or more fields or tokens may be configured in formats that may be indexed by the tracking and mapping database 122 and/or the message sequence tracking and proofing module 124, and may be parsed and decoded by the end-consumer systems. Although this disclosure describes a metadata management system using a particular identifier in a particular manner, this disclosure contemplates metadata management systems using any suitable identifiers in any suitable manner.

In particular embodiments, once the unique ID 115 is generated for the metadata message 107 and assembled into the corresponding metadata record 139 by the microservice 142, the microservice 142 may then log the completed metadata record 139 into the message sequence tracking and proofing module 124 of the tracking and mapping database 122 during the logging event 110.

In particular embodiments, the message sequence tracking and proofing module 124 may be configured as one or more database tables or data storage entities, which may record new metadata records 139 received by the microservices 142 and update processing statuses of the metadata records 139 based on different processing events. As an example and not by way of limitation, the processing statuses of the metadata records 139 may be associated with different stages of processing including but not limited to delivering the metadata records 139 to different modules (e.g., protocol bridge modules, subscriber modules such as queue subscriber 147 (i.e., 147A, 147B . . . ), master queue subscriber (MQS) 146, etc.) or systems (e.g., end-consumer systems) and receiving the metadata records 139 by different modules or systems.

In particular embodiments, depending on the size of the manufacturing, the number of manufacturing equipment 141 connected to or managed by the metadata management system, and other relevant factors, the message sequence tracking and proofing module 124 may be implemented as a single linear database table that logs and maintains the statuses of all metadata records 139. In particular embodiments such as in the case of a complex system with a large number of manufacturing equipment 141 and metadata messages 107 sent from manufacturing equipment 141, the message sequence tracking and proofing module 124 may have one database table allocated for each manufacturing equipment 141. Although this disclosure describes a metadata management system using a particular message sequence tracking and proofing module in a particular manner, this disclosure contemplates metadata management systems using any suitable message sequence tracking and proofing modules in any suitable manner.

In particular embodiments, the message sequence tracking and proofing module 124 may be configured as a book-keeping ledger for the metadata records 139 and their associated event records based on processing events of the metadata records 139. As an example and not by way of limitation, the first step in the ledger may be the first logging of the metadata records 139 by the microservice 142 during the initial logging event 110.

In particular embodiments, the database tables of the message sequence tracking and proofing module 124, which may maintain the metadata records 139, may use the unique ID 115 of the respective metadata record 139 to build one or more searchable indexes, each index serving the respective database table it has been assigned to. This may help find the metadata record 139 and update the processing status thereof. As an example and not by way of limitation, by using the index, searching for a particular metadata record 139 may be done swiftly, and the event record of this metadata record 139 may be updated based on the processing event related to the metadata record 139. As another example and not by way of limitation, when a metadata record 139 is received—e.g., by a queue subscriber that serves a particular end-consumer system—the queue subscriber may ask the message sequence tracking and proofing module 124 to search for that metadata record 139 based on the assigned index. The event record of the metadata record 139 may then be updated, indicating that the metadata record 139 has been fully processed and received by the queue subscriber 147 and its client consumer system 148.

In particular embodiments, the index may be built on alphanumeric values. In particular embodiments, the index may be built on numerical values, which may be faster to search than alphanumeric values. As an example and not by way of limitation, the index may be created based on the unique ID field of the metadata record 139. As another example and not by way of limitation, if the unique ID field is a composite field, the index may be built on the composite field, with each numerical value of the composite field collectively forming the unique ID 115 of the metadata record 139.

In particular embodiments, the message sequence tracking and proofing module 124 may maintain one single record for each metadata record 139, with each record having one or more event record fields such as timestamp fields. As an example and not by way of limitation, each event record field may be related to one of the processing events during the lifecycle of the metadata record 139. As another example and not by way of limitation, each event record field may include one or more event datapoints which may be assigned to record a particular date and time indicating when the corresponding processing event related to the metadata record 139 happens. In particular embodiments, the event record for the metadata record 139 may have a unique ID that enables a subsequent event to search for the metadata record 139 and update the event record of the metadata record 139 related to the subsequent event. Although this disclosure describes a metadata management system using a particular event record in a particular manner, this disclosure contemplates metadata management systems using any suitable event records in any suitable manner.

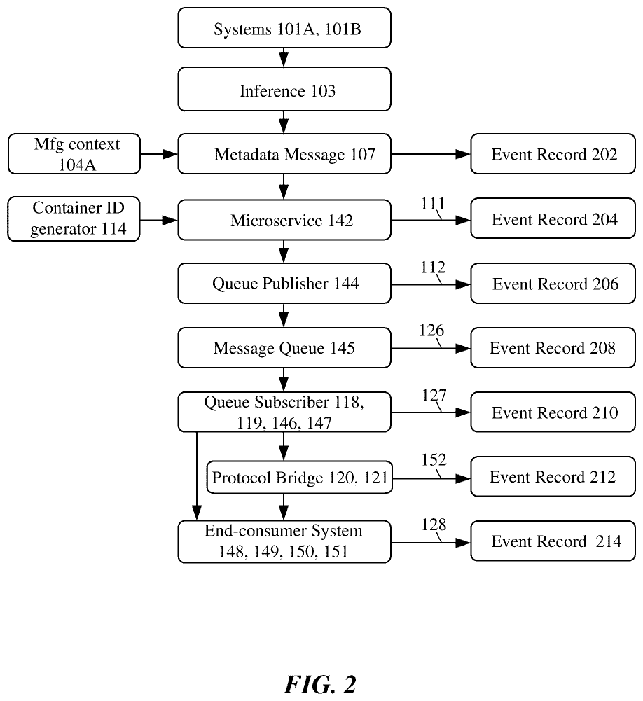

FIG. 2 illustrates a flowchart describing example lifecycles of the metadata messages 107 and metadata records 139. In particular embodiments, event records such as timestamps involved the lifecycle of a metadata message 107 and its associated metadata record 139 may include but not limited to: an event record 202 based on the event creating the metadata message 107; an event record 204 based on the logging event 110 associated with the microservice 142 and the unique ID 115 assignment; an event record 206 based on the logging event 112 associated with the queue publisher module 144; an event record 208 based on the logging event 126 associated with the message queue module 145; an event record 210 based on a logging event 127 associated with the queue subscriber; an event record 212 such as the logging event 152 associated with the protocol bridge; and an event record 214 based on the logging event 128 associated with the end-consumer system.

In particular embodiments, the processing events associated with the metadata record 139 may include but not limited to: the initial logging event 110 that inserts the metadata record 139 having the unique ID 115 in the message queue tracking and proofing module 124; the logging event 112 corresponding to logging the metadata record 139 by the queue publisher module 144; the logging event 126 that logs when the metadata record 139 is fully received by the message queue module 145; the logging event 127 indicating when the queue subscriber 147 of the end-consumer system receives the metadata record 139; the logging event 152 indicating when the protocol bridge receives the metadata record 139; and the logging event 128 corresponding to the final delivery of the metadata record 139 to the end-consumer system, allowing it to consume that metadata record 139.

With continued reference to FIGS. 1-2, as already discussed, in particular embodiments, the metadata records 139 may be published or posted to the message queue module 145 by the respective queue publisher modules 144. In particular embodiments, the message queue module 145 may be configured to decouple the stream of data coming into the message queue module 145 from the stream of data consumed by the receiving systems such as the end-consumer systems. In particular embodiments, the message queue module 145 may also be configured to level down peaks of data flow, for example, when a high number of messages or records are received in a short period of time. In particular embodiments, the decoupling by the message queue module 145 may involve serializing and capturing, for example, at the same time, all metadata messages 107 created by the pool of manufacturing equipment 141. As already discussed, in certain scenarios, when the AI/ML model 102 generates the inference outputs 103, the packet may be sent from one module or entity to another in the delivery chain in a coupled way. This may have the benefit of sending data as soon as possible, for example, in quasi-real-time. However, tightly-coupled systems may not perform well when there are multiple independent systems generating data in parallel with only one centralized receiving or processing system. For these reasons, in particular embodiments, the addition of the message queue module 145 may assist in decoupling of data in order to process data peaks. While decoupling of data flow has advantages, it may also introduce problems such as possible delays in propagating data messages from the source to the end-consumer, potentially compromising the real-time delivery and the deterministic capability of the whole system. Particular embodiments of this disclosure may overcome these challenges by allowing data flow decoupling while maintaining the certainty of delivering messages within desired time thresholds, making the system deterministic.

In particular embodiments, the container manager module 109 that hosts the container modules 143 as well as the container ID 113 may also include another container 117, which may be configured to host a master queue subscriber 146. As an example and not by way of limitation, the master queue subscriber 146 may be configured to subscribe to the metadata records 139 published into the message queue module 145 and, for each published metadata record 139, update a corresponding event record in the message sequence tracking and proofing module 124, e.g., via the logging event 126. This may be beneficial in the overall data flow processing. For example, in certain embodiments, by logging the event record associated with publishing each metadata record 139 by the message queue module 145, the processing sequence of each metadata record 139 may be tracked. As an example and not by way of limitation, at this point, the metadata record 139 may have three event records logged into the message sequence tracking and proofing module 124: (1) the event record 204 when the microservice 142 logs the metadata record 139 for the first time by the logging event 110; (2) the event record 206 associated with the queue publisher module 144; and (3) the event record 208 when the master queue subscriber 146 logs a subscription state of that metadata record 139 inside the message queue module 145 by the logging event 126.

In particular embodiments, the metadata record 139 may also be embedded with the event record 202 indicating the original creation by the manufacturing equipment 141, which, for example, may be implicitly logged into the message sequence tracking and proofing module 124. In some embodiments, this event record 202 may or may not be used in overall delivery proofing since the event record 202 may be created independently of the metadata management system of this disclosure.

In particular embodiments, the event record 208 associated with the logging event 126 may prove that the metadata record 139 has been successfully added and subscribed inside the message queue module 145, thereby assisting delivery proofing. As an example and not by way of limitation, the event record 208 associated with the logging event 126 may be the second token of information checked by the timeout watchdog module 130 to ensure that the metadata record 139 is not lost between the queue publisher modules 144 and the message queue module 145, and that the metadata records 139 arrive and are processed by the message queue module 145, e.g., within a specified time threshold.

In particular embodiments, at receiving endpoints of a digital manufacturing environment, there may be end-consumer systems such as OPC-UA consumer systems 150, industrial protocol consumer systems 151, consumer systems 148, and digital twins 149, which may be configured to consume the metadata records 139. As an example and not by way of limitation, these end-consumer systems may be manufacturing facility Supervisory Control and Data Acquisition (SCADA) systems, Manufacturing Execution Systems (MES), reporting systems, Quality Management Systems, digital twins of different manufacturing processes, Manufacturing Operations Management (MoM) systems, or other suitable systems that consume manufacturing data.

In particular embodiments, a Manufacturing Management System (MMS), such as, for example, Manufacturing Execution System (MES), may operate based on tags and datapoints delivered in quasi-real-time from the automation layers of manufacturing equipment—for example, from programable logic controllers (PLCs) via real-time industrial protocols to the MMS. One example industrial protocol in digital manufacturing used for real-time communication between automation layers zero and one in the Purdue model is the Open Platform Communications-Unified Architecture, or OPC-UA in short. For example, the OPC-UA may enable bridging of the datapoints and tags defined in the automation layers (specifically in the memory addresses of the compatible devices supporting this protocol such as PLCs) to the upper systems (such as MES) in a deterministic and quasi-real-time manner. In particular embodiments, the OPC-UA protocol may be implemented and performed by an OPC-UA client-server software module. Automation devices such as PLCs that implement this protocol may act as OPC-UA servers, sending the datapoints and tags to a client module of an OPC-UA middleware module located in level two or three of the Purdue model. In this regard, for example, the same OPC-UA middleware module may have a server component that passes the datapoints and tags located upstream in the Purdue architecture to the consumer systems such as MES.

However, metadata messages may not follow the deterministic data flow path of the automation tags and datapoints through the above-described industrial protocols because these industrial protocols, by their nature and content, may not be suitable for such data transmission. As such, in some situations, the metadata messages or packets may be sent over non-deterministic protocols that allow for transferring large data packets, such as, for example, Hypertext Transfer Protocol (HTTP). The non-deterministic protocols may be suitable media for transferring data asynchronously. As an example and not by way of limitation, in situations where a piece of manufacturing equipment loses network connection to the upper systems, some or all data in the tags and datapoints that are otherwise usually transmitted over a deterministic industrial protocol may be lost. On the other hand, the source automation devices may be designed to control processes in real-time (such as the PLCs) and thus may not buffer the machine state of the tags or datapoints. Accordingly, in particular embodiments, it may be helpful to send the metadata over non-deterministic protocols such as HTTP, Hypertext Transfer Protocol Secure (HTTPS), etc., whereas when data are not sent—for example, due to network outages—the certainty of delivering messages in a predetermined or maximum amount of time may be limited.

In particular embodiments, one or more protocol bridges such as a MQ2OPC-UA bridge 120, a P2P bridge 121, etc. may be provided to bridge the metadata records 139 to the industrial protocols. As an example and not by way of limitation, existing middleware application servers may consume data through the industrial protocols. In certain embodiments, having a way to pass the metadata messages into the industrial protocols may benefit the legacy consumer systems by exposing a new set of data not available before and allowing the systems to relate the deterministic tags and datapoints to the new manufacturing metadata coming from the corresponding channels.

In particular embodiments, a queue subscriber MQ2OPC-UA module 118 may be configured to subscribe to and receive the metadata records 139 posted into the message queue module 145 through subscription notification events 116. In particular embodiments, once a metadata record 139 is extracted by the queue subscriber MQ2OPC-UA module 118, e.g., through the new message or subscription notification event 116, the metadata record 139 may be passed to the MQ2OPC-UA bridge 120, which may be a type of protocol-to-protocol (P2P) bridge where the output protocol is the OPC-UA standard or other suitable protocol standards.

In particular embodiments, once the metadata record 139 is successfully delivered to the MQ2OPC-UA bridge 120, the queue subscriber MQ2OPC-UA module 118 may log the event record 210 into the message sequence tracking and proofing module 124 via the logging event 127. As an example and not by way of limitation, the event record 210 attached to the currently processed metadata record 139 via the logging event 127 may provide an additional step in the tracking sequence of the metadata record 139.

In particular embodiments, the MQ2OPC-UA bridge 120 may take the structure and fields of the metadata record 139 as received by the queue subscriber MQ2OPC-UA module 118 and convert them into tags and datapoints format of the OPC-UA protocol. In particular embodiments, the MQ2OPC-UA bridge 120 may load, for example, via map loading events 135, the map of metadata structures to OPC-UA or P2P tags and fields, which may be stored in a mapping module 123. As an example and not by way of limitation, the formats and representations of the metadata records 139 may be one of the commonly-used industry formats for messages such as JSON, XML, binary structures, or other suitable formats. However, structuring and formatting the same message into the OPC-UA format may not be a one-to-one match of the fields of the messages. Accordingly, in particular embodiments, mapping of the metadata messages 107 and its corresponding metadata records 139 to the structure and format of the OPC-UA protocol may implemented in the mapping module 123, which may be part of the tracking and mapping database 122. In particular embodiments, the maps may be loaded into different metadata records 139 of different industrial protocols, for example, at the startup of the MQ2OPC-UA bridge 120, via the map loading events 135.

In particular embodiments, the mapping module 123 may take each token of metadata, which, for example, may be a field, a tuple, a nested structure, or other suitable data structures, and map it to those of the OPC-UA tags or datapoints related to the source metadata message 107. As an example and not by way of limitation, mapping of single-token or single-field metadata messages 107 may be simple and straightforward. On the other hand, in the case of a nested structure that maintains the same structure in the target OPC-UA tags, the mapping may be almost direct. Although this disclosure describes a metadata management system using a particular mapping module and protocol bridge in a particular manner, this disclosure contemplates metadata management systems using any suitable mapping modules and protocol bridges (such as any P2P bridges) in any suitable manner.

In particular embodiments, one or more fields or tokens of a metadata message structure or a metadata record structure may be dropped or augmented. In particular embodiments, one or more new synthetic fields or tokens may be created. In particular embodiments, a tree structure of a metadata message 107 may be flattened into a serialized or linear structure for the OPC-UA tag or the P2P protocol tag in general. In particular embodiments, a relatively flat array of fields or tokens may be structured as desired by the end-consumer of the corresponding OPC-UA or P2P tag.

In particular embodiments, mapping between one format and another similar format may be implemented, such as, for example, from the XML format to JSON, whereas in other embodiments, mapping between different formats such as from an American Standard Code for Information Interchange (ASCII) type format to a binary structure may be implemented. In particular embodiments, the mapping module 123 associated with the map of metadata structures to OPC-UA or P2P tags and fields may add convenience to define, add, remove, change, and adjust the details of mapping in a user-friendly and convenient format, which may be used by the MQ2OPC-UA bridge 120 (or the P2P bridge 121) via the map loading event 135.

In particular embodiments, mapping of the metadata records 139 may not necessarily be a one-to-one process. As an example and not by way of limitation, there may be situations where multiple OPC-UA tags or other protocol tags are mapped to a single metadata message. For example, a relatively large metadata message with a large number of fields—either flat or tree-like structure—may be mapped to multiple tags or datapoints on the OPC-UA side. Particular embodiments of this disclosure may increase efficiencies associated with network bandwidth and computing needs by transferring multiple smaller metadata messages instead of larger ones. Moreover, in particular embodiments, the relatively large metadata messages may be mapped to more targeted tags and datapoints, making them more manageable and easier for end-consumer systems to digest.

In particular embodiments, upon the startup initialization of the protocol bridge modules such as the MQ2OPC-UA bridge 120 or the P2P bridge 121, or periodically at predetermined intervals of time, the protocol bridge may be connected to the mapping module 123 via the map loading events 135 and load one or more translation maps.

In particular embodiments, on receiving new messages from the queue subscriber MQ2OPC-UA module 118 or the queue subscriber MQ2P2P module 119, the MQ2OPC-UA bridge 120 or the P2P bridge 121 may construct a destination structure for the corresponding mapped OPC-UA or industrial protocol tag and fill each token or field of data according to the map. When the corresponding OPC-UA or industrial protocol tag is constructed and populated with the values of the incoming message, the MQ2OPC-UA bridge 120 or the P2P bridge 121 may make the updated tag values available to the OPC-UA consumer systems 150 or the industrial protocol consumer systems 151 via events 136.

In particular embodiments, based on the subscription notification event 116 that there is a new metadata record 139 posted by the message queue module 145 and the successful retrieval of that new metadata record 139 by the queue subscriber MQ2OPC-UA module 118 or queue subscribers MQ2P2P module 119 suitable for other industrial protocols, after the metadata record 139 is successfully passed to the MQ2OPC-UA bridge 120 or the P2P bridge 121, the queue subscribers MQ2OPC-UA module 118 and the queue subscribers MQ2P2P module 119 may perform another task for overall message delivery proofing, which is the logging event 127 that logs the successful processing of the metadata record 139 into the message sequence tracking and proofing module 124, proofing that the metadata record 139 has been fully processed and delivered. As an example and not by way of limitation, the logging event 127 may log the event record 210 into the message sequence tracking and proofing module 124. As an example and not by way of limitation, this event record 210 may reflect the full and successful processing of the current metadata record 139 by the queue subscribers (e.g., the queue subscribers MQ2OPC-UA module 118 and the queue subscribers MQ2P2P module 119). Specifically, the event record 210 may reflect that the metadata record 139 is not only received successfully from the message queue module 145 but also delivered successfully to the desired destination such as the MQ2OPC-UA bridge 120 or the P2P bridge 121.

As already explained, in particular embodiments, the metadata record 139 may already be embedded with the unique ID 115. The unique ID 115 may be created earlier in the process, assigned to each metadata record 139, and logged, for example, during the initial logging event 110, into the message sequence tracking and proofing module 124, which may use the unique ID as the main index to be searched and updated by the subsequent logging events 126 and 27 associated with tracking and proofing. In particular embodiments, the event records added to each metadata record 139 (for example, during the updating or logging events 110, 112, 126, 127, 152, and 28) may be the main tokens of information that allow the system to track the sequence of the processing and successful delivery of each metadata message 107 or metadata record 139.

In particular embodiments, the delivery of the metadata records 139 to other end-consumer systems that use different industrial protocols may work in a similar way as the functioning of the queue subscriber MQ2OPC-UA module 118, the MQ2OPC-UA bridge 120, and the OPC-UA consumer systems 150. For example, there may exist other real-time industrial protocols such as Ethernet/IP (Industrial Protocol), Process Field Bus (PROFIBUS), MODBUS, FANUC FOCAS, LSV/2, IO-LINK, Universal Machine Technology Interface (UMATI), MTCONNECT, and so on. These industrial protocols may have the feature of delivering messages originating from the automation layers of the manufacturing equipment 141 in a deterministic and quasi-real-time way to the end-consumer systems that consume the messages. In particular embodiments, the end-consumer systems that communicate with other industrial protocols may implement the same or similar processing method as described above for the OPC-UA consumer systems.

In particular embodiments, the end-consumer system using any of the other industrial protocols may have a dedicated queue subscriber MQ2P2P module 119, which may be suitable for the respective industrial protocol and configured to listen to a new metadata record 139 from the subscription notification event 116 for the respective industrial protocol. As an example and not by way of limitation, upon receiving the subscription notification event 116 of a new metadata record 139 posted into the message queue module 145 and upon successfully retrieving the metadata record 139, the queue subscriber MQ2P2P module 119 may pass the metadata record 139 to the corresponding P2P bridge 121 and log the successful receiving and passing of the metadata record 139 into the message sequence tracking and proofing module 124 via the logging event 127.

In particular embodiments, the logging event 127 may send a logging command to the message sequence tracking and proofing module 124, adding a new event record 210 to the currently processed metadata record 139. As an example and not by way of limitation, this event record 210 may prove that the current metadata record 139 has been successfully subscribed and received from the message queue module 145 as well as successfully passed to the P2P bridge 121.

In particular embodiments, a software module associated with the P2P bridge 121 may connect to a mapping module 125 via the map loading event 135. As an example and not by way of limitation, the mapping module 125 may be located inside the tracking and mapping database 122 and may be configured to store translation maps for mapping metadata structures to industrial protocol tags and fields. In particular embodiments, the P2P bridge 121 may transform the structure of the received metadata record 139 into the structure needed by the industrial protocol consumer system 151 based on the map, which may be received via the map loading event 135, for example, during the startup of the P2P bridge 121. As an example and not by way of limitation, the P2P bridge 121 may be configured to map the data tokens and fields of each metadata record 139 to particular data tokens and fields that are specific to the industrial protocol which the industrial protocol consumer system 151 needs. As an example and not by way of limitation, mapping by the P2P bridge 121 may be similar to those described above with reference to the MQ2OPC-UA bridge 120.

In particular embodiments, once the metadata record 139 has been converted by the P2P bridge 121 into a specific industrial protocol based on the map of the mapping module 125, the P2P bridge 121 may send the transformed and adapted metadata record to the industrial protocol consumer system 151 via the event 136. In particular embodiments, when the P2P bridge 121 successfully passes the transformed metadata record to the industrial protocol consumer system 151 via the event 136, the P2P bridge may log the event record 212 of this new processing status of the current metadata record into the message sequence tracking and proofing module 124 of the tracking and mapping database 122 via the logging event 152. As an example and not by way of limitation, this event record 212, which is added to the processing history of the current metadata record 139 via the logging event 152, may be the last one in the lifecycle of each metadata message 107 and corresponding metadata record 139. For example, the event record 212 may prove that the metadata message 107 was successfully delivered to the end-consumer system. The event record 212 may also mark the closing of a processing history path of each metadata message 107, which is stored by the message sequence tracking and proofing module 124. In particular embodiments, based on the event records associated with processing each metadata message 107 and metadata record 139, the message sequence tracking and proofing module 124 may provide support to prove that the metadata message 107 and its associated metadata record 139 have been completely processed and fully delivered to the end-consumers systems.

In particular embodiments, there may exist some other end-consumer systems that do not need a bridge to transform the format of the metadata records 139 passed by their corresponding queue subscriber. As an example and not by way of limitation, these end-consumer systems may receive and consume the metadata records 139 in their general-purpose formats and correspondingly update their inner machine states. The above-described type of end-consumer systems may be referred to in this disclosure as consumer systems 148. In particular embodiments, there may exist yet other types of end-consumer systems—e.g., the digital twins. As an example and not by way of limitation, the digital twins may be digital representations of manufacturing processes, manufacturing equipment, or a combination of both, replicating in digital formats the machine state of the respective process, piece of equipment, or both. The above-described type of end-consumer systems may be referred to in this disclosure as digital twins 149.

In particular embodiments, both types of end-consumer systems—i.e., consumer systems 148 and digital twins 149—may not require a format conversion of the structure of the metadata records 139. As an example and not by way of limitation, the consumer systems 148 and digital twins 149 may consume the metadata records 139 as is in their native format, which is already open and portable. Example implementation structures may include Javascript Object Notification (JSON), Extensible Markup Language (XML), other ASCII or binary structures and formats, and other suitable data structures and formats.

In particular embodiments, the end-consumer systems such as the consumer systems 148 and digital twins 149 may be paired with corresponding queue subscribers 147. As an example and not by way of limitation, similar to embodiments presented previously, the queue subscribers 147 may listen to new metadata records 139 posted in the message queue module 145. When a new metadata record 139 is posted, the queue subscribers 147 may be notified by the message queue module 145 and retrieve the newly posted metadata record 139 via the subscription notification event 116.

In particular embodiments, upon successfully receiving the metadata record 139, the queue subscriber 147 may log, in the message sequence tracking and proofing module 124, the event record 210 related to the current metadata record 139 via the logging event 127, indicating the successful subscription and retrieval. As an example and not by way of limitation, the event record 210 may prove that the currently processed metadata record 139 has been successfully received by the corresponding queue subscribers 147. Moreover, in particular embodiments, the event record 210 may contribute to deterministic delivery by the metadata management system for example, in addition to proving that the current metadata record 139 has reached a successful state in the respective queue subscriber serving the respective end-consumer system, a metadata record 139 that was lost or not delivered may be resent and re-pushed (e.g., by a retry or resend mechanism) to the corresponding end-consumer system, thereby ensuring a deterministic information delivery.

In particular embodiments, after the queue subscribers 147 have successfully received the metadata records 139 and logged the successful retrieval, via the logging event 127, in the message sequence tracking and proofing module 124 of the tracking and mapping database 122, the queue subscribers 147 may pass the metadata records 139 to the end-consumer systems such as the consumer system 148 and the digital twin 149.

In particular embodiments, the consumer system 148 and the digital twin 149 may ingest the metadata records 139 and update their inner-state machine. As an example and not by way of limitation, when the current metadata record 139 is successfully received and consumed by one or more of the consumer systems 148 and the digital twins 149, these end-consumer systems may update the final processing status of the current metadata record 139 by logging the event record 214 in the message sequence tracking and proofing module 124 of the tracking and mapping database 122 via the logging event 128. For example, the event record 214 logged via the logging event 128 may be similar to those logged by the logging events 28 associated with other end-consumer systems (e.g., OPA-UA consumer systems 150, industrial protocol consumer system 151, etc.). Specifically, the logging event 128 may log a new event record 214 related to the currently processed metadata record 139 by the consumer system 148 or the digital twin 149, proving that the current metadata record 139 has been successfully delivered to the respective end-consumer system, for example, within a specified time threshold.

In particular embodiments, if the event record 214 associated with the event 128 for a particular metadata record 139 is not present in the message sequence tracking and proofing module 124 within a predetermined amount of time, then there may be a retry or resend mechanism configured to resend the metadata record 139 to the respective end-consumer system that did not receive the metadata record 139.

In particular embodiments, a specified threshold corresponding to a predetermined amount of time (e.g., a maximum amount of time) that the metadata message 107 and corresponding metadata record 139 should reach the end-consumer systems or other final destinations may be saved and managed by the message sequence tracking and proofing module 124 of the tracking and mapping database 122. As an example and not by way of limitation, these specified thresholds may be managed at the time of setup (e.g., individually for each metadata message 107 or its associated metadata record 139) or adjusted accordingly by the metadata management system itself—for example, in certain embodiments, the adjustment may be done as part of a self-balance ability that is built in a real-time optimizer module 140, which will be explained further below.

In particular embodiments, upon inspecting a history sequence of each metadata message 107 and metadata record 139, if a metadata record 139 does not have the final event record 214 recorded by the logging event 128, then the message sequence tracking and proofing module 124 may prove that the metadata message 107 has not been fully delivered to the end-consumer systems. In response, a retry or resend mechanism may be activated to resend that metadata message 107 again.

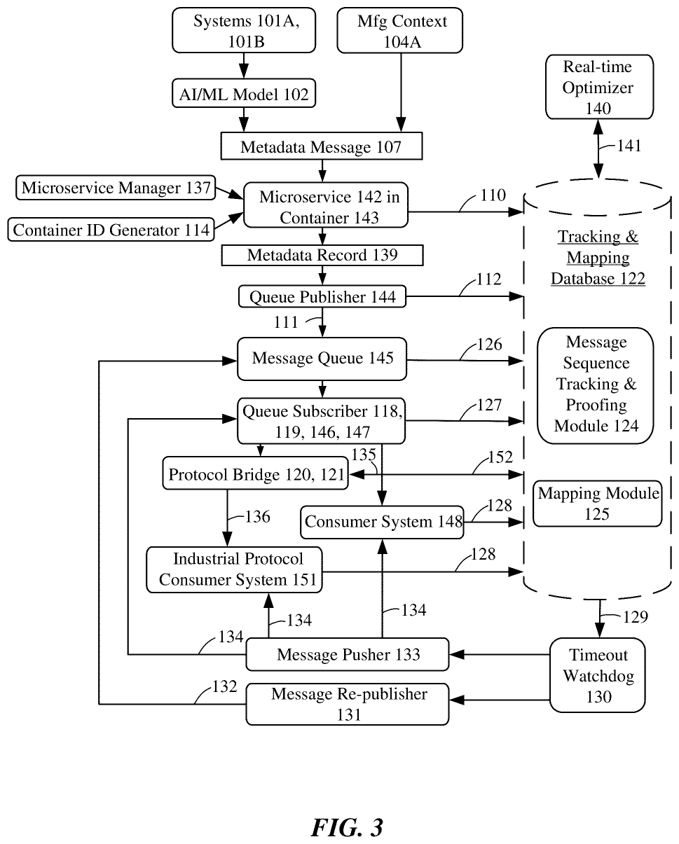

FIG. 3 illustrates a system flowchart of the metadata management system, specifically showing the flow of data between components of the system. In particular embodiments, as discussed, high-speed high-volume manufacturing data collected by the computer systems in the manufacturing equipment such as vision systems 101A and process systems 101B may be processed by AI/ML models 102 running in industrial computers at the edge, generating inference outputs 103 with certain sampling rates. In particular embodiments, the result of the inference output 103 may be augmented with the manufacturing context 104A of the current process into metadata messages 107, which, for example, may be delivered to systems located at the operation layers. In particular embodiments, each type of metadata message 107 may be delivered to a dedicated microservice endpoint 108 belonging to a microservice 142, which is assigned to the corresponding source manufacturing equipment 141 and hosted in the dedicated container module 143.

In particular embodiments, the receiving microservice 142 may be managed by the microservice manager module 137 and designed with one or more endpoints 108, each dedicated to one type of metadata message 107. As an example and not by way of limitation, the microservice 142 may receive a type of metadata message 107 from the message push module 106 of the corresponding manufacturing equipment 141.

In particular embodiments, the microservice 142 may be configured to generate, e.g., via the container ID generator 114, unique IDs to be assigned and attached to each metadata message 107. As an example and not by way of limitation, this may help build the tracing mechanism of the metadata message 107 and aid in the implementation of the retry or resend mechanism that is configured to ensure the delivery of the metadata message 107 or metadata record 139 to the end-consumer systems or other suitable destinations.

In particular embodiments, the unique ID assigned to the metadata message 107 may convert the metadata message 107 into the metadata record 139. In particular embodiments, the microservice 142 may log each newly created metadata record 139 into the message sequence tracking and proofing module 124 and pass the metadata record 139 forward to the corresponding queue publisher module 144 for further processing.

In particular embodiments, the message sequence tracking and proofing module 124 may be configured to store the lifecycle history and delivery sequence of the metadata record 139—e.g., from its inception, which corresponds to the logging event 110, all the way to delivery to the end-consumer systems such as the consumer systems 148 and the industrial protocol consumer systems 151.

In particular embodiments, software modules of the queue publisher modules 144 may each be allocated to the corresponding microservice 142, with both the microservice 142 and the allocated queue publisher module 144 being hosted by the corresponding container module 143.

In particular embodiments, the queue publisher module 144 may be configured to take an instance of metadata record 139 from the microservice 142 that the queue publisher module 144 is paired with, publish the instance of metadata record 139 into the message queue module 145, and update the event record 206 of the metadata record 139 into the message sequence tracking and proofing module 124 via the logging event 112.

In particular embodiments, the message queue module 145 may be configured to receive or accept one or more metadata records 139, which may arrive at random times, and notify respective queue subscribers of the metadata records 139 about the arrival and presence of new metadata records 139. As an example and not by way of limitation, this may be achieved by decoupling the arrival events of the metadata records 139 from their subscription and consumption events. This may allow a large number of data sources to push data packets randomly, whereas the processing of the packets may happen asynchronously from the sourcing systems. Furthermore, it may in turn allow the source systems to continue performing their functions without being held back by the end-consumer systems.

In particular embodiments, the message queue module 145 may log, via the logging event 126, the event record 208 related to each metadata record 139 when successful receipt of the metadata record 139 by the message queue module 145 is confirmed.

In particular embodiments, the end-consumer system may have or be assigned a dedicated queue subscriber 147, which may be notified by the message queue module 145 when a new metadata record 139 has been posted and is ready to be retrieved. In particular embodiments, when the queue subscriber 147 successfully retrieves the metadata record 139 and sends it, for example, to the consumer system 148, the protocol bridges such as MQ2OPC-UA bridge 120 or P2P bridge 121, or other suitable destinations, the queue subscriber 147 may log a new event record 210 of the respective metadata record 139 into the message sequence tracking and proofing module 124 by the logging event 127.

At this stage, in particular embodiments, there may be two delivery options depending on the destination of the metadata record 139. As an example and not by way of limitation, in a first situation—where the queue subscriber 147 passes the metadata record 139 to an end-consumer system such as the consumer system 148, which does not need format conversion, protocol conversion, or other types of data conversion—after the consumer system 148 successfully ingests the metadata record 139, the consumer system 148 may log, via the logging event 128, an event record 214 associated with the current metadata record 139 in the message sequence tracking and proofing module 124, confirming the end-to-end successful delivery of the metadata record 139.

As another example and not by way of limitation, in a second situation—where the queue subscriber 147 passes the metadata record 139 to an end-consumer system that needs to digest the metadata record 139 in a different format or from a different protocol, such as, for example, an industrial protocol—the queue subscriber 147 may send the metadata record 139 to a protocol bridge such as the MQ2OPC-UA bridge 120 or P2P bridge 121, where the current structure and format of the metadata record 139 may be converted into a structure and format compatible with the destination protocol while retaining the data values and meaning of the metadata record 139. In certain embodiments, the MQ2OPC-UA bridge 120 or P2P bridge 121 may convert the structure and format of the metadata record 139 based on the map which is stored in the mapping module 125 of the tracking and mapping database 122 and loaded or retrieved by the map loading event 135. In certain embodiments, upon the successful structure and format conversion and the delivery of the metadata record 139 to the protocol bridge or its associated end-consumer system (e.g., the industrial protocol consumer system 151), the MQ2OPC-UA bridge 120 or P2P bridge 121 may log the event record 212 of the current metadata record 139 into the message sequence tracking and proofing module 124 via the logging event 152. Alternatively or additionally, in particular embodiments, the industrial protocol consumer system 151 may also log the successful ingestion of the metadata record 139 into the message sequence tracking and proofing module 124 by the logging event 128.

In particular embodiments, the message sequence tracking and proofing module 124 may maintain a specified threshold, which may correspond to a maximum end-to-end delivery time for each type of metadata message 107 or metadata record 139 and for different stages of delivery of each instance of a message type.

In particular embodiments, the timeout watchdog module 130 may continuously monitor the processing status of each metadata record 139 by analyzing the respective event records of the logging events 110, 112, 126, 127, 152, and 128. As an example and not by way of limitation, if a time difference between the current time and the time datapoint associated with the last logging event of the metadata record 139 is greater than the specified threshold, then the timeout watchdog module 130 may initiate a retry or resend mechanism to republish or resend the faulty metadata record 139.

In particular embodiments, the specified threshold associated with each metadata message or record type may be adjusted continuously by the real-time optimizer module 140. In some embodiments, the real-time optimizer module 140 may analyze the event record history of each metadata message type. In some embodiments, the real-time optimizer module 140 may build a time-series distribution of the event record datapoints and compute the specified threshold based on the delivery time history. As more datapoints of each type are processed, the real-time optimizer module 140 may acquire more data to compute, generating a more precise threshold for each metadata record, thus becoming a self-learning, self-optimizing mechanism.

In particular embodiments, with continued reference to FIGS. 1 and 3, depending on the specific stage at which delivery failure of the metadata record 139 occurs, the timeout watchdog module 130 may send the faulty metadata record 139 to a message re-publisher module 131 or a message pusher module 133. As an example and not by way of limitation, if the metadata record 139 has not been delivered to or otherwise confirmed by the message queue module 145, the timeout watchdog module 130 may send the faulty metadata record 139 to the message re-published module 131, which may re-publish the metadata record 139 into the message queue module 145. On the other hand, as an example and not by way of limitation, if the metadata record 139 has been confirmed by the message queue module 145 but not delivered to the end-consumer system, such as, for example, the MQ2OPC-UA bridge 120, P2P bridge 121, consumer system 148, etc., the timeout watchdog module 130 may push, via the message pusher module 133, the metadata record 139 directly to the end-consumer system.

Particular embodiments may allow the metadata messages or records to be sent over non-deterministic protocols such as HTTP, which are suitable for sending data with large volumes or structures while decoupling or loosely coupling the source system from the end-consumer system. Moreover, information delivery may be implemented with certainty, making the delivery process deterministic, which, for example, is desirable in critical mission environments such as digital manufacturing environments. Particular embodiments may also provide a modular system architecture design, thus managing changes in manufacturing data generation in a flexible way.

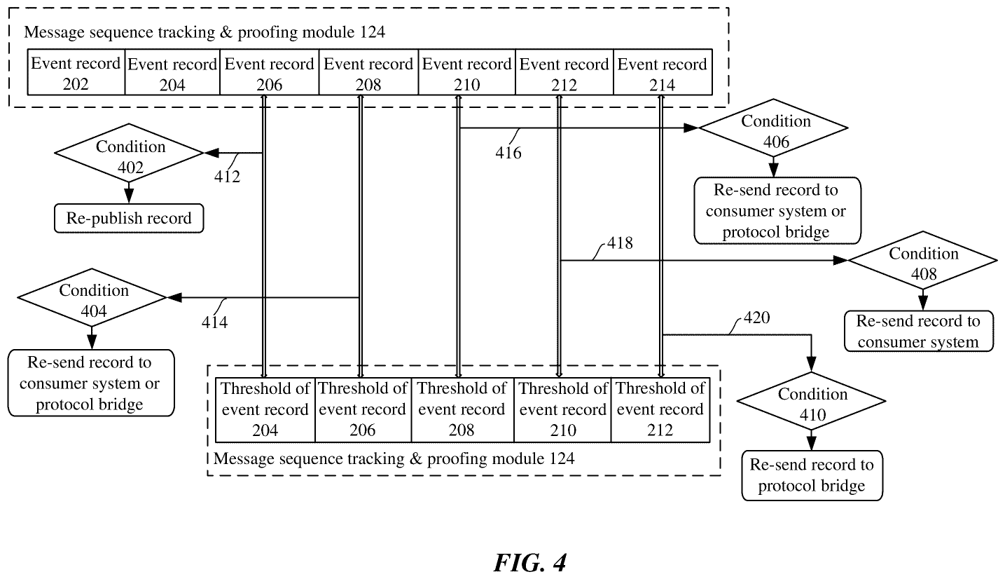

FIG. 4 illustrates a sequence of logical decisions by the timeout watchdog module 130. In particular embodiments, as discussed, the timeout watchdog module 130 may be a software module that implements delivery proofing and retry or resend mechanisms, and, for example, may work in conjunction with the message sequence tracking and proofing module 124, the message re-publisher module 131, the message pusher module 133, or other suitable computing modules or systems. In particular embodiments, the timeout watchdog module 130 may run in a closed loop. As an example and not by way of limitation, the timeout watchdog module 130 may constantly read the event records such as timestamps of the metadata record 139 logged in the message sequence tracking and proofing module 124 to identify the processing status of the metadata record 139. As an example and not by way of limitation, the processing status may be a status indicating whether the metadata record 139 has been delivered to a subsequent module (e.g., the subscriber modules, protocol bridge, etc.) in the delivery chain or to the end-consumer systems (e.g., the consumer systems 148, the digital twins 149, the industrial protocol consumer systems 151, etc.). As an example and not by way of limitation, the metadata records 139 that were not delivered may be records that do not have one or more event records 204, 206, 208, 210, 212 logged by the associated logging events 112, 126, 127, 152, or 128.

In particular embodiments, the timeout watchdog module 130 may analyze each metadata record 139 that is present in the message sequence tracking and proofing module 124. As an example and not by way of limitation, the metadata record 139 may be found or inspected in different stages of delivery to the end-consumer systems, which will be explained in the following.

In particular embodiments, in a first situation where a metadata record 139 was just inserted in the message sequence tracking and proofing module 124 by the event 110, therefore having the initial event record 204 of the event 110, the timeout watchdog module 130 may subtract, at step 412, the event datapoint such as the timestamp value of the event record 204 from a current time value and compare the time difference with a specified threshold (e.g. a predetermined maximum value) that is associated with the event record 204. As an example and not by way of limitation, the specified threshold may be stored in the message sequence tracking and proofing module 124 as a general value for all metadata records 139 or a customized value for each type of metadata record 139. In particular embodiments, at condition 402, if the timeout watchdog module 130 determines that the time lapse since the event record 204 exceeds the specified threshold since the event record 204 and that the event record 206 for the subsequent logging event 112 associated with the queue publisher module 144 is not present, it may indicate that the respective metadata record 139 has been logged by the corresponding microservice 142 during the logging event 110 but not received by the corresponding queue publisher module 144, not acknowledged by the logging event 112 associated with the queue publisher module 144, or otherwise lost or missing. For example, it may be possible that the corresponding queue publisher module 144 did not receive the metadata record 139, or that the logging event 112 failed because the queue publisher module 144 was not able to log the metadata record 139 into the tracking and mapping database 122. As a solution, in particular embodiments, the timeout watchdog module 130 may initiate an attempt to re-publish the metadata record 139 back in the message queue module 145. As an example and not by way of limitation, the timeout watchdog module 130 may pass the metadata record 139 to the message re-publisher module 131, which may be a queue publisher dedicated to the timeout watchdog module 130 and configured to re-publish the metadata record 139 that was not received by the message queue module 145, not logged by the corresponding queue publisher module 144 via the logging event 112, not acknowledged by the master queue subscriber 146 via the logging event 126, or lost or missing for other reasons. In particular embodiments, the message re-publisher module 131 may re-publish the lost metadata record 139 found by the timeout watchdog module 130 to the message queue module 145 through a queue re-publishing event 132. In particular embodiments, the message re-publisher module 131 may also update the tracking event record of the re-posted metadata record 139, which is associated with the logging event 126. As an example and not by way of limitation, this event record may prove that the metadata record 139 has been received by a queue publisher—i.e., the message re-publisher module 131—and the tracking of the metadata record 139 may continue from this stage of message delivery. In particular embodiments, if this metadata record 139 is lost again, the timeout watchdog module 130 may catch the metadata record 139 at the next iteration of its scanning loop, which may repeat one or more of the above-described steps to re-publish the metadata record 139.

In particular embodiments, a second situation may be the timeout watchdog module 130 scanning for the event datapoints of the event record 208 associated with the logging event 126, that is the event confirming that the metadata records 139 have been successfully posted in the message queue module 145 and that the master queue subscriber 146 acknowledges the successful publish and firsthand subscription of the metadata records 139. As an example and not by way of limitation, at step 414, the timeout watchdog module 130 may subtract the event datapoint recorded by the logging event 126 of the metadata record 139 from a current time value and compare the result with a specified threshold for the event record 208. In particular embodiments, at condition 404, if the timeout watchdog module 130 determines that the difference is higher than the specified threshold and that the event record 210 for the subsequent logging event 127 associated with the queue subscriber (e.g., the master queue subscriber 146) is not present, it may indicate that the respective metadata record 139 was not successfully subscribed by the queue subscribers, not delivered to the end-consumer systems or other destinations, or otherwise lost. In response, in particular embodiments, the timeout watchdog module 130 may pass the lost metadata record 139 to the message pusher module 133, which may push the metadata record 139 to the protocol bridges (e.g., the MQ2OPC-UA bridge 120 or the P2P bridge 121) or directly to the end consumers (e.g., the consumer system 148), depending on the end destination. In particular embodiments, the timeout watchdog module 130 may then update the event record 210 associated with the particular queue subscriber that missed the notification event 116.

In particular embodiments, other situations may be that the timeout watchdog module 130 encounters metadata record loss for a repeated number of times, then the next step for the timeout watchdog module 130 may be to pass the metadata record 139 to the message pusher module 133 and update the event record associated with the logging event 126 or 127. As an example and not by way of limitation, the timeout watchdog module 130 may send the faulty metadata record 139 directly to the message pusher module 133. In particular embodiments, at steps 416, 418, and 420, the timeout watchdog module 130 may determine whether respective conditions 406, 408, and 410 are satisfied and, based on the determination, send the metadata record 139 to the message pusher module 133, which may then send the metadata record 139 to its destination modules or systems. The conditions 406, 408, and 410 may be similar to the conditions 402 and 404 described above—the timeout watchdog module 130 may determine that the time lapse since a particular event record exceeds the specified threshold since the event record and that a subsequent event record is not present. In particular embodiments, if the metadata record 139 does not need a format or structure translation, then the message pusher module 133 may take the lost metadata record 139 and send it directly to the consumer systems 148 or the digital twins 149. In particular embodiments, if the metadata record 139 needs to be translated into a format or structure suitable for protocol bridges such as the MQ2OPC-UA bridge 120 or the P2P bridge 121, then the message pusher module 133 may take the lost metadata record 139 and send it to the MQ2OPC-UA bridge 120 or the P2P bridge 121 via a message pushing event 134. Accordingly, the message pusher module 133 may update the event records associated with the logging events 126, 127, and 152.

As an example and not by way of limitation, example conditions which may be determined by the timeout watchdog module 130 are summarized in Table 1 below.

TABLE 1

| Example | |
|---|---|
| Conditions | Determination by Timeout Watchdog Module |
| Condition 402 | Time lapse since event record 204 exceeds specified |
| | threshold and event record 206 not present |
| Condition 404 | Time lapse since event record 206 exceeds specified |
| | threshold and event record 208 not present |
| Condition 406 | Time lapse since event record 208 exceeds specified |
| | threshold and event record 210 not present |
| Condition 408 | Time lapse since event record 210 exceeds specified |
| | threshold and event record 212 not present |
| Condition 410 | Time lapse since event record 212 exceeds specified |
| | threshold and event record 214 not present |

In particular embodiments, the timeout watchdog module 130 may determine that a metadata record 139 has the event record logged by the logging event 128, and that the metadata record 139 has been successfully delivered to the end-consumer systems within the specified time threshold. Responsively, the message sequence tracking and proofing module 124 may clean the metadata record 139 and, for example, move it into another database or table for historical analytics and historical proofing. In this way, the main working table of the message sequence tracking and proofing module 124 may be kept as small as possible, efficiently reserved for the metadata records 139 that are currently under processing. Moreover, as an example and not by way of limitation, by moving the fully processed and delivered metadata records 139 elsewhere, the message sequence tracking and proofing module 124 may efficiently rebuild the search indexes for the metadata records 139. This may facilitate one or more modules or components of the metadata management system to add event records such as delivery timestamps to the metadata record 139, search for the currently processed metadata record 139, and execute the logging event for event record update much faster.

Accordingly, particular embodiments of this disclosure may offer a way to deliver metadata messages or records through electronic media, which are decoupled from the source to the destination, over non-deterministic protocols while allowing deterministic end-to-end information delivery.

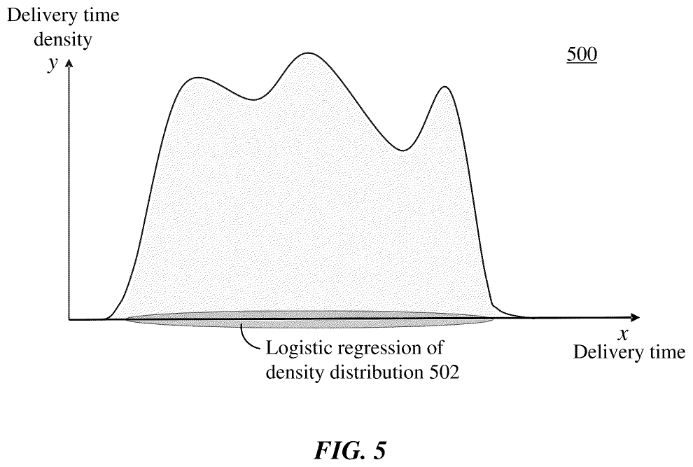

FIG. 5 illustrates a distribution chart 500 showing the distribution of message or record delivery density, which may be used to determine the specified threshold for a particular metadata record 139. A typical industrial protocol today may have a built-in mechanism to implement the certainty of delivery. A threshold time for delivery is built into the industrial protocol and is thus independent of the messages or data packets to be delivered. Put differently, the maximum amount of time that the protocol delivers the messages or data packets applies universally, therefore it may not be possible to adjust or customize the time threshold based on specific needs or for specific message types. As a solution, in particular embodiments, a mechanism may be provided, in which the specified time threshold of the metadata messages or records may be adjusted, customized, and optimized by analyzing the distribution of metadata record delivery density.

As previously discussed, in particular embodiments, the tracking and mapping database 122 may maintain a table associated with the metadata record 139. As an example and not by way of limitation, one field in the table may be configured to reflect the specified threshold of time that the metadata record 139 should be delivered to the end-consumer systems or other destinations along the delivery path. In particular embodiments, the specified threshold may be determined based on a general processing history of different metadata records 139 and self-tuned and adjusted for individual metadata record 139. In particular embodiments, this may be implemented by the real-time optimizer module 140, which may be configured to learn from the history of metadata records 139 (which may be constantly loaded in the message sequence tracking and proofing module 124) and generate a distribution chart for the metadata records 139. As an example and not by way of limitation, this may be done during quiet times of the day, which may include production breaks, breaks between shifts, non-production times such as night-times and weekends, etc. In particular embodiments, when a quiet period starts, the real-time optimizer module 140 may scan the history of processed metadata records 139, analyze the event record and event datapoints of the metadata record 139, and compute the distribution chart or representation of individual message type.

In particular embodiments, the distribution chart 500 may include an x-axis indicating metadata record delivery time, which may be the small incremental delivery time of each metadata record 139, and a y-axis indicating the density of delivery time. In particular embodiments, the density of delivery times may not necessarily have a Gaussian distribution across the delivery times. As an example and not by way of limitation, there may be many factors that influence the message delivery times, and therefore the density distribution may be represented by a polynomial function, which may be specific to each metadata record type.

In particular embodiments, the real-time optimizer module 140 may set upper and lower boundaries of the distribution of each metadata record type as the desired specified threshold of the metadata record, and then update the threshold of each metadata record type, which is stored in the tracking and mapping database 122. Moreover, in particular embodiments, the real-time optimizer module 140 may follow this specific algorithm and take into account a variety of factors specific to each metadata record. As an example and not by way of limitation, one of the factors may be the frequency of each metadata record. To build a proper distribution of values, the real-time optimizer module 140 may need a sufficient amount of metadata record. In certain embodiments, if a particular metadata record type has a low frequency, the real-time optimizer module 140 may build the distribution when enough of those particular metadata records have been accumulated in the message sequence tracking and proofing module 124. In embodiments where metadata records have a relatively high frequency, building the distribution and choosing the upper limit may be done at each processing iteration of the real-time optimizer module 140.

In particular embodiments, the real-time optimizer module 140 may run the event datapoints, which may represent the delivery time of the metadata record 139, at each step of the delivery path through a logistic regression algorithm 502. As an example and not by way of limitation, since the delivery time distribution may be non-linear and non-Gaussian, the logistic regression algorithm 502 may build a polynomial function that approximates the delivery time distribution of the metadata record 139. In particular embodiments, by running the logistic regression on the event datapoints of the metadata records, the logistic regression algorithm 502 may compute the most fitted boundaries for the delivery time of each metadata record 139 at each delivery step, in order to determine a specified threshold for a particular metadata record type associated with a particular processing event. This approach may be more desired compared to other approaches of selecting limits based on simple statistical methods. It may also accurately provide a specified threshold specifically for a particular metadata record type instead of having a global arbitrary maximum value for all.

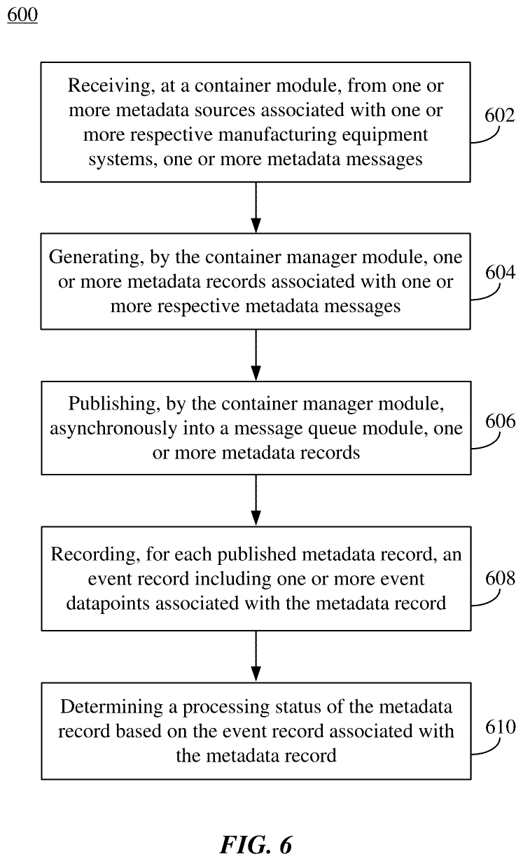

FIG. 6 illustrates an example method 600 for metadata management in manufacturing systems, which may be compatible with and/or implemented by various embodiments of the metadata management systems described herein or other suitable systems for metadata management in manufacturing systems. The method 600 may begin at step 602, where the container manager module may receive, from one or more metadata sources associated with one or more respective manufacturing equipment systems, one or more metadata messages. As an example and not by way of limitation, the metadata sources may be message push modules that are located in or otherwise associated with the corresponding manufacturing equipment system. As another example and not by way of limitation, the container manager module may include one or more container modules, each corresponding to one manufacturing equipment system. As a further non-limiting example, each container module may include a microservice, which is configured to receive metadata messages from the respective metadata source, e.g., via one or more endpoints.

At step 604, the container manager module may generate one or more metadata records, which are associated with the metadata messages, with each metadata record being decoupled from the metadata sources. As an example and not by way of limitation, the metadata record may include the corresponding metadata message as well as a unique identifier assigned to the metadata message. As another example and not by way of limitation, the unique identifier may be assigned by the microservice of each container module.

At step 606, the container manager module may publish the metadata records asynchronously into a message queue module. As an example and not by way of limitation, the publishing may be done via queue publisher modules. Specifically, for example, each container module may include a corresponding queue publisher module, which is configured to publish the metadata records to the message queue module.

At step 608, one or more software modules associated with a metadata tracking database (or a metadata tracking and mapping database as used interchangeably herein) may record, for each published metadata record, an event record. The event record may include one or more event datapoints associated with the metadata record. Each event datapoint may be based on a processing event associated with the metadata record. As an example and not by way of limitation, the processing event may be associated with the container manager module, the message queue module, one or more end-consumer systems, one or more subscriber modules associated with the end-consumer systems, or other suitable modules or systems for metadata management. As another example and not by way of limitation, the processing event may correspond to a processing event type, such as, for example, delivering the metadata record to one or more subscriber modules each associated with one or more end-consumer systems, receiving the metadata record by the one or more subscriber modules, delivering the metadata record to the one or more end-consumer systems, receiving the metadata record by the one or more end-consumer systems, or other suitable types of processing event involved in metadata management in manufacturing systems. As a further non-limiting example, each event datapoint may include a time record or timestamp value indicating when the corresponding processing event is completed.

At step 610, a processing status of the metadata record may be determined based on the event record associated with the metadata record. As an example and not by way of limitation, the processing status of the metadata record may correspond to a status indicating that the metadata record is lost or otherwise failed to be delivered to a desired destination. For example, in particular embodiments, a first event datapoint associated with a first metadata record may be compared with a specified threshold or predetermined value that is associated with the processing event corresponding to the first event datapoint. Based on a determination that the specified threshold associated with the processing event is exceeded, the processing event may be reinitiated. As another example and not by way of limitation, the processing status of the metadata record may correspond to a status indicating that the metadata record has been successfully delivered to a desired destination. For example, in particular embodiments, the successful delivery may be determined based on a predetermined condition, which, for example, may correspond to a condition where, for each processing event, there exists an event record or datapoint associated with the processing event (in other words, no event record or datapoint is missing), a condition where the processing event for a first metadata record is completed within a threshold period of time, or other suitable conditions as disclosed herein. In certain embodiments, based on determining that the processing status of the first metadata record satisfies the predetermined condition, subsequent determination of the processing status of the first metadata record may be terminated. Moreover, when the predetermined condition is satisfied, the event record for the first metadata record may be removed from the metadata tracking database.

Although not specifically illustrated, the method of FIG. 6 may include other steps. In particular embodiments, the message queue module may generate a subscription event corresponding to each published metadata record. Each subscription event may be configured to notify one or more subscriber modules, each associated with one or more end-consumer systems. Each metadata record may be further decoupled from the end-consumer systems. As an example and not by way of limitation, the subscriber modules may be configured to convert metadata records into a format corresponding to an industrial protocol associated with the end-consumer systems that are in turn associated with the subscriber module. In particular embodiments, a distribution for each metadata record may be generated based on the event record of the metadata record. As an example and not by way of limitation, a threshold for a particular processing event may be determined based on the distribution and may be specific to each type of the metadata record.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for metadata management including the particular steps of the method of FIG. 6, this disclosure contemplates any suitable method for metadata management including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

Accordingly, particular embodiments of this disclosure may provide a solution to the processing and delivery of data in a manufacturing environment, which, for example, may not be suitable to be sent over deterministic industrial protocols due to various reasons such as data sizes, structures, frequencies, or other reasons associated with the computing devices that generate messages and already have built-in non-deterministic transport protocols, etc. Particular embodiments of this disclosure may provide decoupling of metadata messages or records—in this regard, for example, the source system may be loosely coupled or relatively decoupled from the receiving system—while ensuring delivering the message packets with certainty and in a deterministic way. In particular embodiments, by decoupling the source systems from the destination systems, problems at the destination systems (such as slow down, receiving deficiency, etc.) may be prevented from slowing down, backpropagating, holding back, or otherwise impacting the source systems, or vice versa. Particular embodiments of this disclosure may offer a solution to situations where messages are sent over non-deterministic protocols, deterministic protocols that are decoupled between source and destination by the message queues, or a combination of both, making the end-to-end delivery of messages in these conditions deterministic, traceable, and certain.

Particular embodiments of this disclosure may allow self-tuning and adjusting the maximum delivery time for each message type. As an example and not by way of limitation, this may be done by analyzing the delivery history of each message type, building a distribution of delivery density, and deciding on delivery time thresholds or boundaries, for example, by running a logistic regression algorithm that may fit the modeling function to the dataset. In certain embodiments, the maximum delivery time may be continuously learned and updated by the logistic regression algorithm or a ML model as the metadata management system processes more messages and keeps re-training the ML model.

Particular embodiments of this disclosure may involve a modular and manageable way of receiving metadata messages by container modules, each being dedicated to one piece of manufacturing equipment. As an example and not by way of limitation, each container module may host a microservice, which has one or more endpoints, each being designed for and dedicated to receiving one type of metadata message. This modular approach may facilitate easy management of each container module, microservice, and corresponding endpoints. For example, in certain embodiments, if a new piece of equipment is added to a manufacturing space, a container manager may launch a new container module, which may host a new microservice serving that new piece of equipment. In other embodiments, if an existing piece of equipment has a new type of metadata message, the corresponding microservice may easily add a new endpoint to serve the new type of metadata message without impacting or affecting the processing of the other types of messages. In further embodiments, if the signature of an existing metadata message changes, for example, by adding a new field to the message structure, only the corresponding endpoint dedicated to that type of message may need to be updated, while avoiding impacting other message types managed by the corresponding microservice. Accordingly, particular embodiments of this disclosure may be more robust and resilient to changes and updates.

Particular embodiments of this disclosure will be described, in the following, in the context of laser cleaning of battery cell caps and power electrodes in battery module manufacturing, with a focus on the early phases of data generation, which, for example, may be associated with the automation layers involving the manufacturing equipment 141 and other components, modules, or systems described herein. Although this disclosure describes a metadata management system used in a particular digital manufacturing process in a particular manner, this disclosure contemplates metadata management systems used in any suitable digital manufacturing processes in any suitable manner.

In particular embodiments, an example process in battery module manufacturing may involve a pre-welding laser cleaning step, where the feedback of the process may be provided by a computer vision system such as the vision system 101A, which is configured to perform a visual inspection of the statuses of cleanliness of electrode caps of the batteries and related connecting output power wires.

In particular embodiments, a machine learning or deep learning model (e.g., the AL/ML model 2), a neural network model, or other AI algorithms may process raw images at certain time intervals and generate a multi-class inference such as the inference output 103. As an example and not by way of limitation, the inference output 103 may not be a single discrete value, but a structure of values depicting cleanliness level, oxidation level, rugosity level, corrosive spots, and other suitable variables of the components to be laser welded.

In particular embodiments, the result of each inference output 103 may be augmented with the specifics of the current battery module, which may include, in addition to the date and timestamp of the operation: the battery cell ID or position within the battery module, the module ID, the batch ID, the manufacturing work order ID, the equipment ID, the operator ID, environment humidity, or other environment parameters such as temperature, atmospheric pressure, environment cleanliness in parts per million, or other suitable parameters that may impact the quality of the manufacturing process.

In particular embodiments, a possible metadata message—e.g., the metadata message 107—may include a unique ID of each individual battery cell that is assembled into the battery module. This may help trace any possible quality defects or manufacturing non-conformance of each battery cell or benefit the end-to-end manufacturing traceability of each battery cell.

In particular embodiments, an event aggregator software module such as the event aggregator module 105 may combine and augment the inference output 103 of the AI/ML model 102 with the manufacturing context parameter into the data structure, which may self-describe the current snapshot of each metadata message 107.

In particular embodiments, the metadata message 107 may be pushed by the message push module 106 to a computing platform such as the container modules 143. In certain instances, some of these metadata messages 107 may be quite large. As an example and not by way of limitation, one battery module may be made of hundreds of battery cells. If the amount of data collected and assembled for each battery cell is multiplied by the number of cells, the result may be a large data structure. One example protocol that may be used by the message push module 106 to send the metadata messages 107 is HTTP or HTTPS. As already explained, HTTP or HTTPS is a non-deterministic protocol used for structured and unstructured data transfer such as the Internet, which may be suitable to send or upload relatively small or large amounts of data in a stateless transfer. HTTP and HTTPS are increasingly utilized in manufacturing for transferring data that is not real-time or deterministic. Moreover, using HTTP in manufacturing environments may facilitate implementation in the software that runs at the edge of industrial computers.

Moreover, for example, in traditional manufacturing, data may be collected during the manufacturing process but sent to the operations layer systems only after the whole manufacturing process is finalized. However, in the example context of the battery module laser cleaning process, the laser cleaning equipment may clean the electrode caps of each battery cell one at a time—that is, the equipment may perform the cleaning process for every battery cell very rapidly. Hence, it may not be suitable to send one metadata message after laser cleaning each battery cell because the speed of data transmission may not match the rapid cleaning speed of the equipment. In such situations, the data structure collected from the cleaning of each battery cell may be buffered by the computing system of the equipment. In particular embodiments, when the equipment completes the cleaning process of the last battery cell in the current battery module, the event aggregator module 105 may aggregate all data structures specific to each battery cell into one large metadata message 107, which is specific to the whole battery module, and send the metadata message 107 to the computing platforms such the container modules 143, as previously discussed.

Again, although this disclosure describes a metadata management system used in a particular digital manufacturing process in a particular manner, this disclosure contemplates metadata management systems used in any suitable digital manufacturing processes in any suitable manner. In this regard, for example, there may exist various situations and combinations of situations similar to the ones described, where the collected and augmented data may be aggregated at lower or higher levels before being pushed to particular embodiments of the metadata management system of this disclosure. Moreover, for example, various combinations of data aggregation and various timing of pushing the aggregated data structure may be compatible with particular embodiments of the metadata management system without departing from the scope of this disclosure.

### Systems and Methods

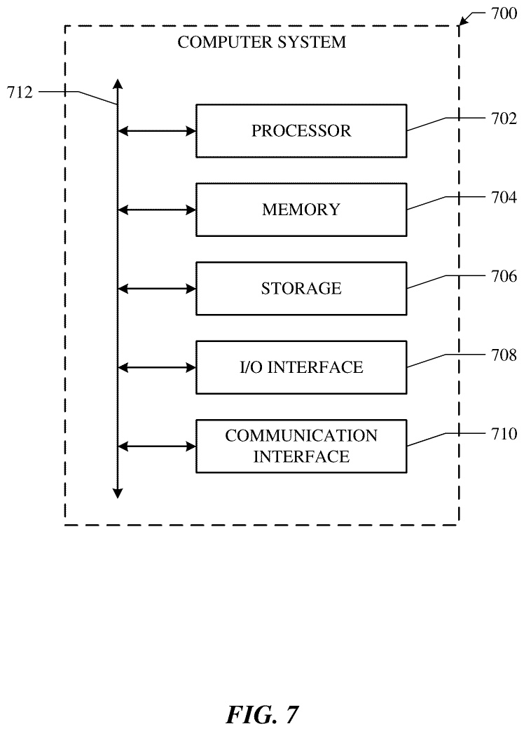

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real-time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems for metadata management in manufacturing systems:
receiving, at a container manager module, from a plurality of metadata sources associated with a respective plurality of manufacturing equipment systems, a plurality of metadata messages;
generating, by the container manager module, a plurality of metadata records associated with the respective plurality of metadata messages, wherein each metadata record is decoupled from the metadata sources;
publishing, by the container manager module, asynchronously into a message queue module, the plurality of metadata records;
recording, by one or more software modules associated with a metadata tracking database, for each published metadata record, an event record comprising one or more event datapoints associated with the metadata record, wherein each event datapoint is based on a processing event associated with the metadata record; and
determining a processing status of the metadata record based on the event record associated with the metadata record.

2. The method of claim 1, further comprising:
generating, by the message queue module, a subscription event corresponding to each published metadata record, wherein each subscription event is configured to notify one or more subscriber modules each associated with one or more end-consumer systems, and wherein each metadata record is further decoupled from the end-consumer systems.

3. The method of claim 2, wherein one or more of the subscriber modules are configured to convert metadata records into a format corresponding to an industrial protocol associated with one or more of the end-consumer systems associated with the subscriber module.

4. The method of claim 1, wherein each processing event is associated with one or more of the container manager module, the message queue module, one or more end-consumer systems, or one or more subscriber modules associated with one or more of the end-consumer systems.

5. The method of claim 1, wherein each metadata record comprises a unique identifier assigned to the associated metadata message.

6. The method of claim 5, wherein recording the event record and determining the processing status of the metadata record is based on the unique identifier assigned to the associated metadata message.

7. The method of claim 5, wherein the container manager module comprises a plurality of container modules, and wherein each container module corresponds to a manufacturing equipment system of the plurality of manufacturing equipment systems.

8. The method of claim 7, wherein each container module comprises a microservice configured to receive metadata messages from the metadata source associated with the manufacturing equipment system corresponding to the container.

9. The method of claim 8, wherein each microservice is configured to assign the unique identifier to the received metadata message to generate the associated metadata record.

10. The method of claim 8, wherein the microservice comprises a plurality of endpoints to receive the metadata messages from the metadata source, and wherein each endpoint is dedicated to receiving a particular type of metadata message.

11. The method of claim 7, wherein each container module further comprises a queue publisher module configured to publish metadata records to the message queue module.

12. The method of claim 1, further comprising:
monitoring, via a timeout watchdog module, the processing status of the metadata record by analyzing one or more event datapoints associated with the metadata record.

13. The method of claim 1, further comprising:
comparing, for a first metadata record of the plurality of metadata records, a first event datapoint associated with the first metadata record with a specified threshold associated with the processing event corresponding to the first event datapoint; and
reinitiating the processing event based on a determination that the specified threshold associated with the processing event is exceeded.

14. The method of claim 13, wherein each event datapoint comprises a time record indicating when the corresponding processing event is completed, and wherein the specified threshold is a threshold period of time associated with the processing event.

15. The method of claim 13, wherein reinitiating the processing event comprises re-publishing the first metadata record to the message queue module.

16. The method of claim 1, further comprising:
determining, for a first metadata record of the plurality of metadata records, that a first event datapoint is missing from the event record for the first metadata record; and
reinitiating a processing event corresponding to the first event datapoint based on the determination that the first event datapoint is missing from the event record.

17. The method of claim 1, further comprising:
determining, for a first metadata record of the plurality of metadata records, that the processing status of the first metadata record satisfies a predetermined condition; and
terminating subsequent determinations of the processing status of the first metadata record.

18. The method of claim 17, wherein each event datapoint comprises a time record indicating when the corresponding processing event is completed, and wherein the predetermined condition is a threshold period of time associated with completion of one or more processing events for the first metadata record.

19. The method of claim 18, further comprising:
removing the event record for the first metadata record from the metadata tracking database when the processing status of the first metadata record satisfies the predetermined condition.

20. The method of claim 1, further comprising:
generating a distribution for each metadata record based on the event record of the metadata record; and
determining a threshold for a particular processing event based on the distribution, the threshold being associated with a type of the metadata record.

21. The method of claim 1, wherein each processing event corresponds to one of a plurality of processing event types comprising:
delivering the metadata record to one or more subscriber modules each associated with one or more end-consumer systems;
receiving the metadata record by the one or more subscriber modules;
delivering the metadata record to the one or more end-consumer systems; or
receiving the metadata record by the one or more end-consumer systems.

22. A system for digital manufacturing comprising: one or more processors; and one or more computer-readable non-transitory storage media coupled to one or more of the processors and comprising instructions operable when executed by one or more of the processors to cause the system to:
receive, at a container manager module, from a plurality of metadata sources associated with a respective plurality of manufacturing equipment systems, a plurality of metadata messages;
generate, by the container manager module, a plurality of metadata records associated with the respective plurality of metadata messages, wherein each metadata record is decoupled from the metadata sources;
publish, by the container manager module, asynchronously into a message queue module, the plurality of metadata records;
record, by one or more software modules associated with a metadata tracking database, for each published metadata record, an event record comprising one or more event datapoints associated with the metadata record, wherein each event datapoint is based on a processing event associated with the metadata record; and
determine a processing status of the metadata record based on the event record associated with the metadata record.

23. One or more computer-readable non-transitory storage media embodying software that is operable when executed to:
receive, at a container manager module, from a plurality of metadata sources associated with a respective plurality of manufacturing equipment systems, a plurality of metadata messages;
generate, by the container manager module, a plurality of metadata records associated with the respective plurality of metadata messages, wherein each metadata record is decoupled from the metadata sources;
publish, by the container manager module, asynchronously into a message queue module, the plurality of metadata records;
record, by one or more software modules associated with a metadata tracking database, for each published metadata record, an event record comprising one or more event datapoints associated with the metadata record, wherein each event datapoint is based on a processing event associated with the metadata record; and
determine a processing status of the metadata record based on the event record associated with the metadata record.
